(19) United States
(12) Patent Application Publication
(10) Pub. No.: US 2013/0013471 A1
(43) Pub. Date: Jan. 10, 2013

(54) LOCATION-BASED TAX RATE ACQUISITION AND MANAGEMENT

(75) Inventor: Jayme Fishman, Middleton, MA (US)

(73) Assignee: Second Decimal, LLC, Burlington, MA (US)

(21) Appl. No.: 13/544,925

(22) Filed: Jul. 9, 2012

Related U.S. Application Data
(60) Provisional application No. 61/505,814, filed on Jul. 8, 2011.

(51) Int. Cl. G06Q 40/00

(52) U.S. Cl. 705/31

(57) ABSTRACT

Various embodiments are provided for location-based tax rate acquisition and management. Acquisition comprises access to various types of tax rates (sales tax rates, use tax rates, specialty tax rates, user-defined tax rates, etc.) for one or more tax jurisdictions in a geographical or geopolitical area. In one aspect, acquisition can comprise a monitoring service to track changes in tax information, such as tax rates, for a specific location, changes in tax rates for a specific jurisdiction, or changes in tax jurisdiction boundaries.

### CROSS-REFERENCE TO RELATED APPLICATIONS

This application relates to and claims the benefit of U.S. Provisional Patent Application No. 61/505,814, filed Jul. 8, 2011, which is incorporated herein by reference in its entirety.

### SUMMARY

The disclosure relates, in one aspect, to location-based tax rate acquisition. Acquisition can comprise access to various types of tax rates (e.g., sales tax rates, use tax rates, specialty tax rates, etc.) for a plurality of tax jurisdictions in a geographical or geopolitical area. In addition or in the alternative, acquisition can comprise monitoring services to track one or more of changes in tax rates for a specific location, changes in tax rates for a specific jurisdiction, and/or changes in tax jurisdiction boundaries.

In one aspect, the disclosure provides an example system that can comprise a memory having computer-executable instructions and data, and a processor functionally coupled to the memory and configured, for example, by the computer-executable instructions, to receive data representative of a location; to associate the location to a data structure indicative of the location, the data structure residing in the memory and being mapped to a tax jurisdiction; to identify the tax jurisdiction associated with the data structure, and to assign a tax rate to the location based at least on the tax jurisdiction. In one aspect, the data representative of the location can be received from a mobile device. In another aspect, the processor can be further configured, by the computer-executable instructions, to store the data representative of the location in the memory.

According to another aspect, the disclosure provides an exemplary method that can comprise receiving, by a computer, data representative of a location; associating, by the computer, the location to a data structure indicative of the location, where the data structure can be mapped to a tax jurisdiction; identifying, by the computer, the tax jurisdiction associated with the data structure; and assigning a tax rate to the location based at least on the tax jurisdiction. In one aspect, the receiving step in the exemplary method can comprise receiving the data from a mobile device.

In a yet another aspect, the disclosure can provide a computer-readable non-transitory storage medium that can comprise a first group of computer-executable instructions that, in response to execution, cause a processor to receive data representative of a location; a second group of computer-executable instructions that, in response to execution, cause the processor to associate the location to a data structure indicative of the location, where the data structure can be mapped to a tax jurisdiction; a third group of computer-executable instructions that, in response to execution, cause the processor to identify the tax jurisdiction associated with the data structure; and a fourth group of computer-executable instructions that, in response to execution, cause the processor to assign a tax rate to the location based at least on the tax jurisdiction.

In still another aspect, the disclosure can provide an exemplary mobile device that can comprise a memory including computer-executable instructions and data; and a processor functionally coupled to the memory and configured, by the computer-executable instructions, to transmit data representative of a location to a location-based tax rate acquisition engine and to receive, from the location-based tax rate acquisition engine, a tax rate associated to a tax jurisdiction related to the location in response to the transmission of the data. In another aspect, the processor can be further configured, by the computer-executable instructions, to receive information related to the tax rate. In yet another aspect, the processor can be further configured, by the computer-executable instructions, to receive information associated with the tax jurisdiction.

Location-based tax rate acquisition in accordance with the subject disclosure can be implemented as a unique web service that provides various efficiencies, such as automation of tax rate access for a plurality of tax jurisdiction and related monitoring that are largely unavailable in conventional technologies. Additional aspects, features, or advantages of the subject disclosure will be set forth in part in the description which follows, and in part will be obvious from the description or may be learned by practice of the subject disclosure. The advantages of the subject disclosure will be realized and attained by means of the elements and combinations particularly pointed out in the appended claims. It is to be understood that both the foregoing general description and the following detailed description are exemplary and explanatory only and are not restrictive of the subject disclosure.

### BRIEF DESCRIPTION OF THE DRAWINGS

The accompanying drawings are an integral part of the subject disclosure and illustrate exemplary embodiment(s) of the subject disclosure and together with the description and claims appended hereto serve to explain various principles, features, and/or aspects of the subject disclosure.

FIG. 1-3 illustrates high-level block diagram of example embodiments in accordance with one or more aspects of the disclosure.

FIG. 4 illustrates a computing environment that enables various aspects of location-based tax rate acquisition in accordance with one or more aspects described herein.

FIG. 5 illustrates an exemplary method for acquiring location-based tax rates in accordance with one or more aspects of the subject disclosure.

FIG. 6 illustrates an example end-user interface for consumption (e.g., jurisdiction lookup) of tax information in accordance with one or more aspects of the subject disclosure.

FIG. 7 illustrates an example end-user interface for consumption (e.g., lookup) of tax information in accordance with one or more aspects of the subject disclosure.

FIG. 8 illustrates an example end-user interface for consumption (e.g., lookup) of tax information in accordance with one or more aspects of the subject disclosure.

FIG. 9 illustrates an example end-user interface for consumption (e.g., lookup) of tax information in accordance with one or more aspects of the subject disclosure.

FIG. 10 illustrates an example end-user interface for consumption of tax information for a specific geocode in accordance with one or more aspects of the subject disclosure.

FIG. 11 illustrates an example end-user interface for consumption of tax information (e.g., tax rates for a geocode) in accordance with one or more aspects of the subject disclosure.

FIG. 12 illustrates an example end-user interface for consumption of historical tax information (e.g., tax rate) in accordance with one or more aspects of the subject disclosure.

FIG. 13 illustrates an example end-user interface for a map option in accordance with one or more aspects of the subject disclosure.

FIG. 14 illustrates an example end-user interface for jurisdiction lookup in accordance with one or more aspects of the subject disclosure.

FIG. 15 illustrates an example end-user interface for configuration of an end-user (e.g., a company) information in accordance with one or more aspects of the subject disclosure.

FIG. 16 illustrates an example end-user interface for representation of a hierarchical structure in accordance with one or more aspects of the subject disclosure.

FIG. 17 illustrates an example end-user interface for location mapping in accordance with one or more aspects of the subject disclosure.

FIG. 18 illustrates an example end-user interface for acquisition of geocodes in accordance with one or more aspects of the subject disclosure.

FIG. 19 illustrates an example end-user interface for acquisition of geocodes and rates in accordance with one or more aspects of the subject disclosure.

FIG. 20 illustrates an example end-user interface for location mapping in accordance with one or more aspects of the subject disclosure.

FIGS. 21A-21C illustrates an example end-user interface for update of tax information and location information in accordance with one or more aspects of the subject disclosure.

FIG. 22 illustrates an example end-user interface for management (e.g., generation) of a report in accordance with one or more aspects of the subject disclosure.

FIG. 23 illustrates an example end-user interface for administration of location and/or tax information, and reporting thereof, in accordance with one or more aspects of the subject disclosure.

FIG. 24 illustrates an example end-user interface for representation of a hierarchical structure in accordance with one or more aspects of the subject disclosure.

FIG. 25 illustrates an example end-user interface for administration of tax information in accordance with one or more aspects of the subject disclosure.

FIG. 26 illustrates an example end-user interface for location mapping in accordance with one or more aspects of the subject disclosure.

FIG. 27 illustrates an example end-user interface for administration of location and/or tax information in accordance with one or more aspects of the subject disclosure.

### DETAILED DESCRIPTION

The disclosure can be understood more readily by reference to the following detailed description of exemplary embodiments of the disclosure and to the Figures and their previous and following description.

As used in the specification and the appended claims, the singular forms “a,” “an” and “the” include plural referents unless the context clearly dictates otherwise

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

In the subject specification and in the claims which follow, reference may be made to a number of terms which shall be defined to have the following meanings: “Optional” or “optionally” means that the subsequently described event or circumstance may or may not occur, and that the description includes instances where said event or circumstance occurs and instances where it does not.

As employed in this specification and annexed drawings, the terms “unit,” “component,” “interface,” “system,” “engine,” “platform,” and the like are intended to include a computer-related entity or an entity related to an operational apparatus with one or more specific functionalities, wherein the computer-related entity or the entity related to the operational apparatus can be either hardware, a combination of hardware and software, software, or software in execution. One or more of such entities are also referred to as “functional elements.” As an example, a unit may be, but is not limited to being, a process running on a processor, a processor, an object, an executable computer program, a thread of execution, a program, a memory (e.g., a hard disc drive), and/or a computer. As another example, a unit can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a unit can be an apparatus that provides specific functionality through electronic functional elements without mechanical parts, the electronic functional elements can include a processor therein to execute software or firmware that provides at least in part the functionality of the electronic functional elements. The foregoing example and related illustrations are but a few examples and are not intended to be limiting. Moreover, while such illustrations are presented for a unit, the foregoing examples also apply to a component, a system, a platform, and the like. It is noted that in certain embodiments, or in connection with certain aspects or features thereof, the terms “unit,” “component,” “system,” “interface,” “engine,” “platform” can be utilized interchangeably.

Throughout the description and claims of this specification, the word “comprise,” “include,” and “have,” and variations of such words, such as “comprising” and “comprises,” “including,” and “includes,” and “has” and “having” mean “including but not limited to,” and are not intended to exclude, for example, other features, functional elements, components, integers, or steps. “Exemplary” means “an example of” and is not intended to convey an indication of a preferred or ideal embodiment. “Such as” is not used in an exhaustive, restrictive sense, but rather for explanatory purposes.

Some embodiments of the disclosure are described herein with reference to block diagrams and flowchart illustrations of methods, systems, apparatuses, devices, and computer program products. It will be understood that each block of the block diagrams and flowchart illustrations, and combinations of blocks in the block diagrams and flowchart illustrations, respectively, can be implemented by computer-accessible (e.g., computer-readable and/or computer-executable) instructions. These computer-accessible instructions may be loaded onto a general purpose computer, special purpose computer, or other programmable data processing apparatus to produce a machine, such that the specific instructions that execute on the computer or other programmable data processing apparatus can create a means for implementing the functions specified in the flowchart block(s) and/or high-level block diagrams.

These computer-accessible instructions also can be stored in a computer-readable memory that, in response to execution by a processor, can direct a computer or other programmable data processing apparatus to function in a particular manner in accordance with one or more aspects of the disclosure. Such instructions stored in the computer-readable memory can produce, in one aspect, an article of manufacture including specific computer-accessible instructions for implementing the functionality specified in the flowchart block or blocks. The computer program instructions can be loaded onto a computer or other programmable data processing apparatus to cause a series of operational actions (or steps) to be performed on the computer or other programmable apparatus to produce a computer-implemented process such that the instructions that execute on the computer or other programmable apparatus can implement steps for providing the functionality specified in the flowchart block(s) and/or high-level block diagrams described herein.

It should be appreciated that, in one aspect, two or more blocks of the block diagrams and flowchart illustrations can support combinations of means for performing the described functionality, combinations of steps for performing the specified functionality and program instruction means for performing the specified functionality. It also can be understood that each block of the block diagrams and flowchart illustrations, and combinations of blocks in the block diagrams and flowchart illustrations, can be implemented by special purpose hardware-based computer systems, processing units, and/or processors that can perform the specified functions or steps, or combinations of special purpose hardware and computer instructions.

Reference will now be made in detail to the various embodiments, aspects, and features of the subject disclosure, examples of which are illustrated in the accompanying drawings. Wherever possible, the same reference numbers are used throughout the drawings to refer to the same or like parts.

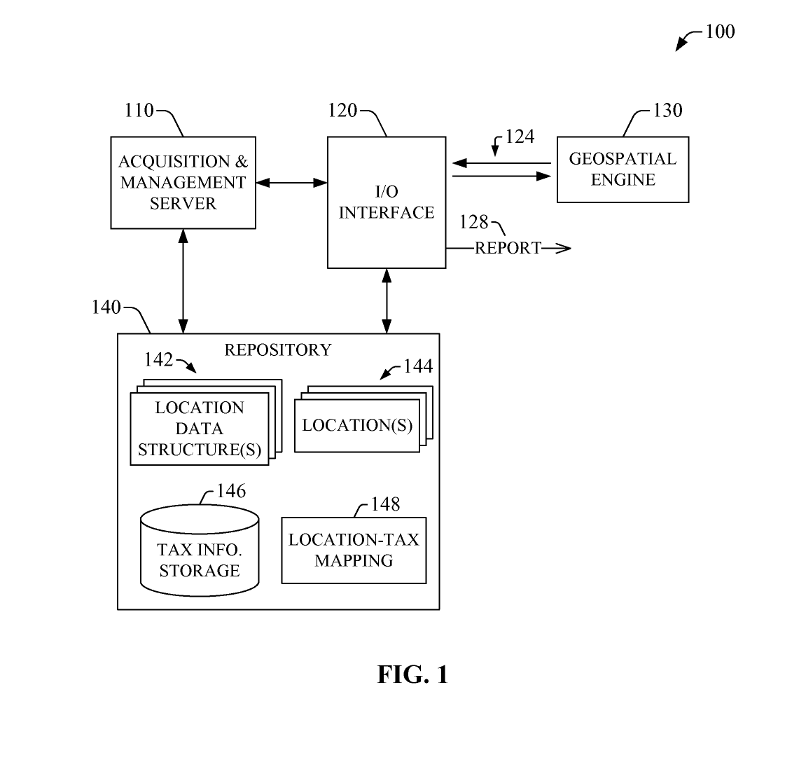

As described in greater detail below, the disclosure relates, in one aspect, to assigning, storing and managing tax rates (e.g., sales tax rates, use tax rates, user-defined rates, etc.) for multiple business locations in various taxing jurisdictions (also referred to as tax jurisdictions) within a geographic area or a geopolitical area. In one aspect, the various tax jurisdictions can be within the United States and/or Canada. In addition to standard lookup features related to tax regulations, certain embodiments of the disclosure can uniquely store locations and associate those locations to data structures indicative of a location that can be mapped to tax rates. Such location data structures can comprise federal information processing standards (FIPS) codes; zone improvement plan (ZIP) codes; latitude and longitude; latitude, longitude, and elevation; and so forth. In certain embodiments, such data structures can be referred to as “geocodes.” As illustrated in the example embodiment in FIG. 1, a repository 140 can retain the locations in one or more memory elements 144 (e.g., registers, memory pages, files, databases, combinations thereof, or the like). In addition, the repository 140 can retain the geocodes in one or more memory elements 142 (e.g., registers, memory pages, files, databases, combinations thereof, or the like) labeled as location data structure(s) 142. The geocodes can be acquired from a geospatial engine 130 that can maintain location information for one or more locations. The location information can be retained in one or more memory elements 152 contained in a repository 150. The location information for a specific location can be available (e.g., persisted in a memory element) with a specific spatial resolution or with several spatial resolutions.

In the example system 100, an acquisition and management (A&M) server 110 can map a location data structure (or geocode) to a tax rate or other portion of tax information, such as information indicative of a tax jurisdiction. In one aspect, to generate a mapping of a location data structure and tax information, the A&M server 110 can associate a location data structure with one or more tax rates specific to a tax jurisdiction associated with the location indicated by the location data structure. In another aspect, to obtain information indicative of a tax jurisdiction, the example system 100 includes or can be coupled to a geospatial engine 130 that can resolve an address into a tax jurisdiction. In one implementation, the geospatial engine 130 can be functionally coupled to an input/output (I/O) interface 120 that can transmit a query (not shown), comprising an address, to geospatial engine 130 via communication links 124. In one implementation, the communication links 124 can comprise wireless links or wired links, or a combination thereof, and can include a downstream link (DL) and an upstream link (UL) that can permit exchange of information between the geospatial engine 130 and the I/O interface 120. In response to the query, and the address conveyed therein, the geospatial engine 130 can supply information (e.g., data or metadata) indicative of a tax jurisdiction.

In one aspect, the acquisition and management (A&M) server 110 can receive information (e.g., data and/or metadata) through the I/O interface 120, which can be part of a computing device (mobile or otherwise) external to the A&M server 110. In additional or alternative embodiments, the A&M server 110 can received information directly from the geospatial engine 130. In other embodiments, e.g., in the example system 200, the A&M server 240 received information in accordance with one or more aspects of the disclosure directly from the geospatial engine 130.

In one aspect, mapping such data structures to respective tax rates can permit accessing updates to the tax rates related to the locations indicated by the data structures and/or determining (nearly instantaneously or in nearly real-time, for example) which tax rates have changed for such locations. In certain implementations, the A&M server 110 can update the information contained in memory element 146, which is labeled as tax information storage 146. To at least such end, as described herein, the A&M server 110 can collect tax information from one or more sources (e.g., information repositories; not shown) having specific information containers (e.g., files or other digital documents). In one aspect, the A&M server 110 can perform an update to the tax information asynchronously, in response to a request to update certain portions of such information.

In one aspect, as illustrated in FIG. 1, tax rates and/or updates thereto (e.g., updated information indicative of tax rates) can be provided in a report 128 including, for example, names of locations for which tax rates have changed and differences in tax rates resulting from the updates. The report 128 can be provided (e.g., transmitted) in a variety of formats and can be communicated to a variety of computing devices (wireless or otherwise).

In additional or alternative embodiments, a web-services application programming interface (API) can be exposed to permit querying a system that can implement location-based tax rate acquisition. For instance, the example system 200 can illustrate one of such embodiments. As illustrated the example system 200 can comprise a client unit 210 (which can be referred to as an agent device or agent) that is functionally coupled to a network 220 (e.g., a wide area network (WAN), a local area network (LAN), an enterprise network, a home area network, or the like) via communication links 214, wherein the network 220 includes a geospatial engine 230 and the A&M server 240. In one implementation, the client unit 210 can comprise an I/O interface 212 that, in response to execution by a processor (e.g., a processor (not shown) of the client unit 210), can embody the web-service API. The communication links 214 can comprise wired link(s), wireless link(s), or a combination thereof, and can include a DL and an UL. The wired link(s) can include one or more of an optical fiber, coaxial cable, universal serial bus (USB) cable, or the like.

In one aspect, through utilization of a provider of a geospatial engine (e.g., the geospatial engine 230), the web-services API and associated resident data can enable automated rate assignment by location based at least on one or more of (a) longitude (long.) and latitude (lat.), or longitude, latitude, and elevation, resolved from a postal address, for example; or (b) as raw (long., lat.) data or (long., lat., elevation) data. In one aspect, to resolve latitude and longitude; or latitude, longitude, and elevation, from a standard postal address, the geospatial engine 230 integrated with or coupled to the example system 200 for location-based tax rate acquisition can reformat the postal address, add a +4 (e.g., a 4-digit code) to the ZIP, convert the reformatted address to latitude and longitude, and then return the tax jurisdiction. In certain implementations, the geospatial engine can be accessed without a web-services API because an agent (e.g., an end-user device, a client computer, etc.) can access the functionality of the geospatial engine from a system for location-based tax rate acquisition in scenarios in which such system is integrated with the geospatial engine and exposes, or provides, the combined functionality via one or more local interfaces (e.g., one or more graphical user interfaces) and/or in web-services enabled, at least in part, by the system.

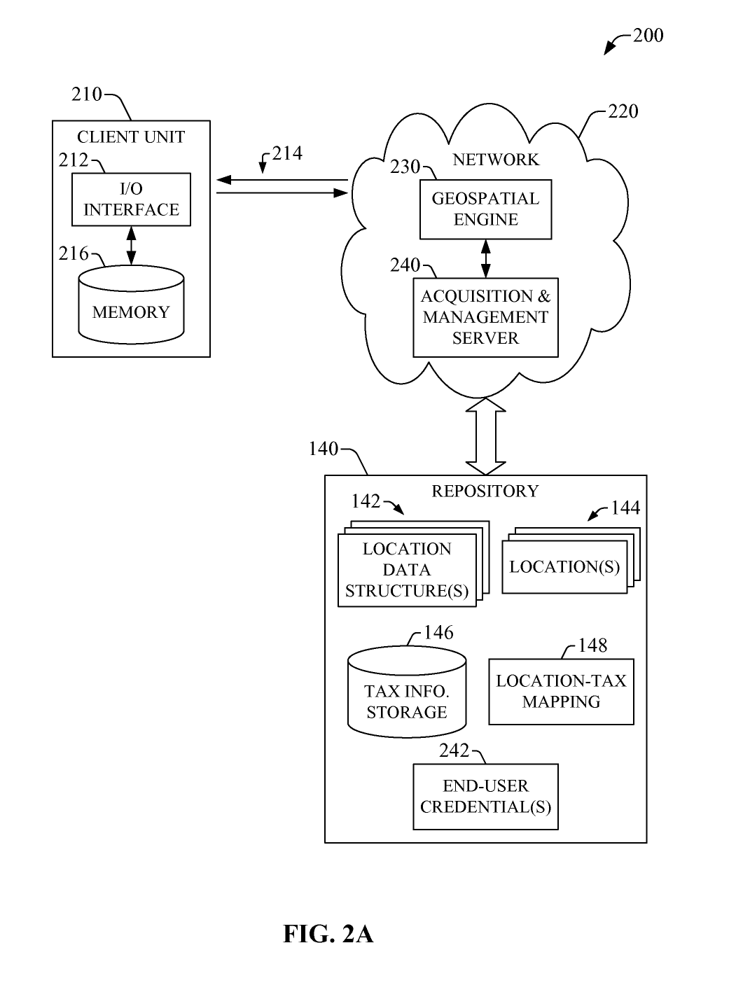

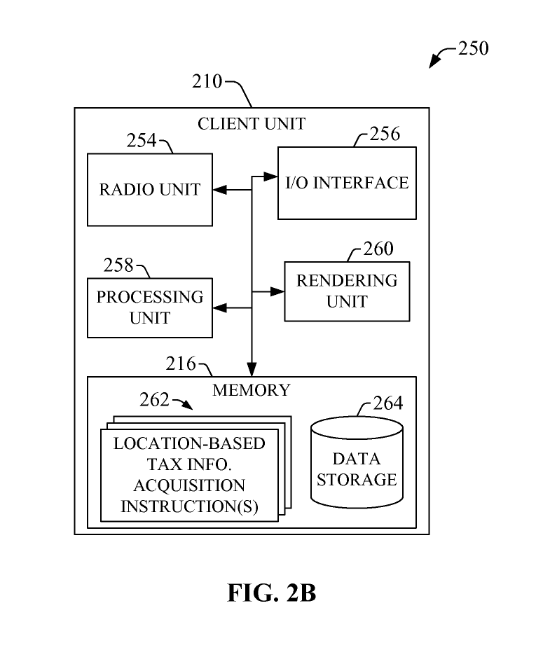

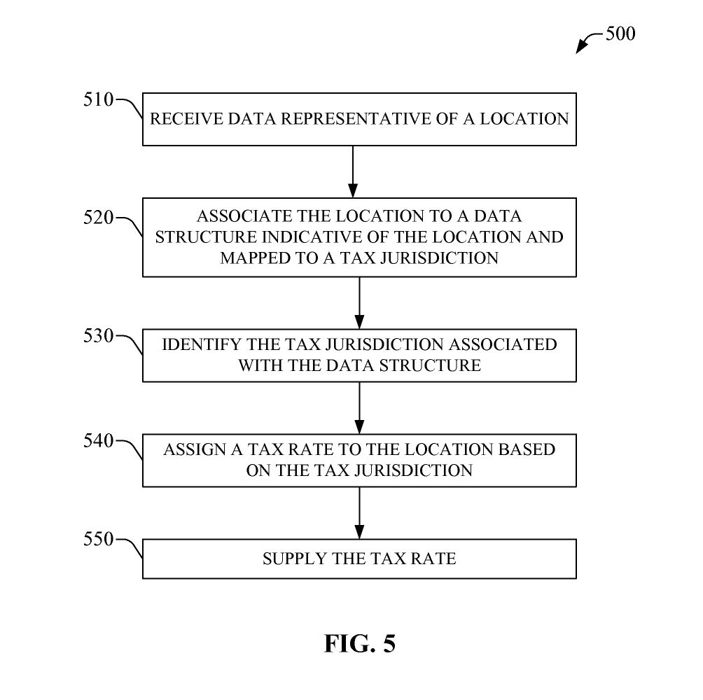

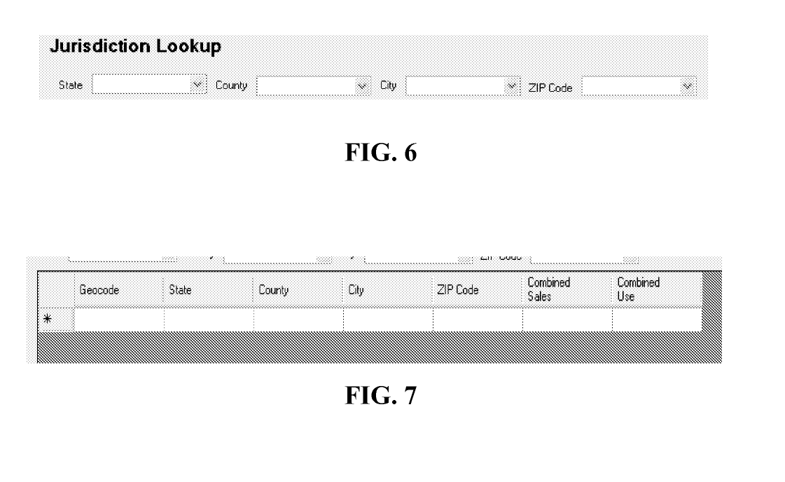

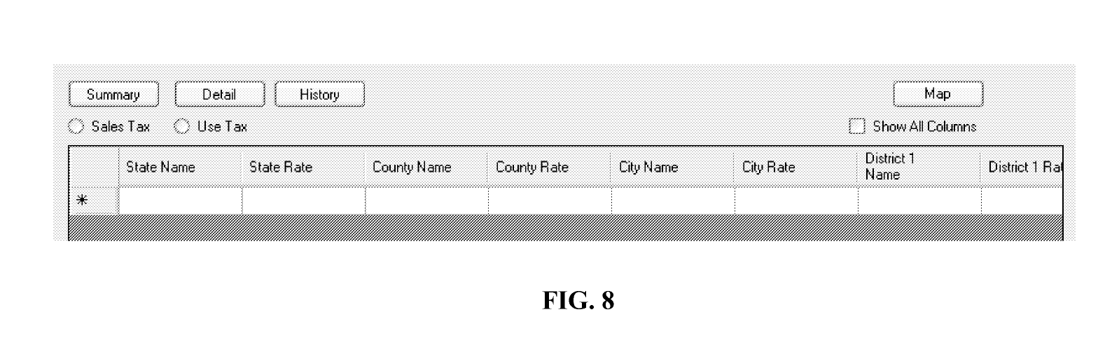

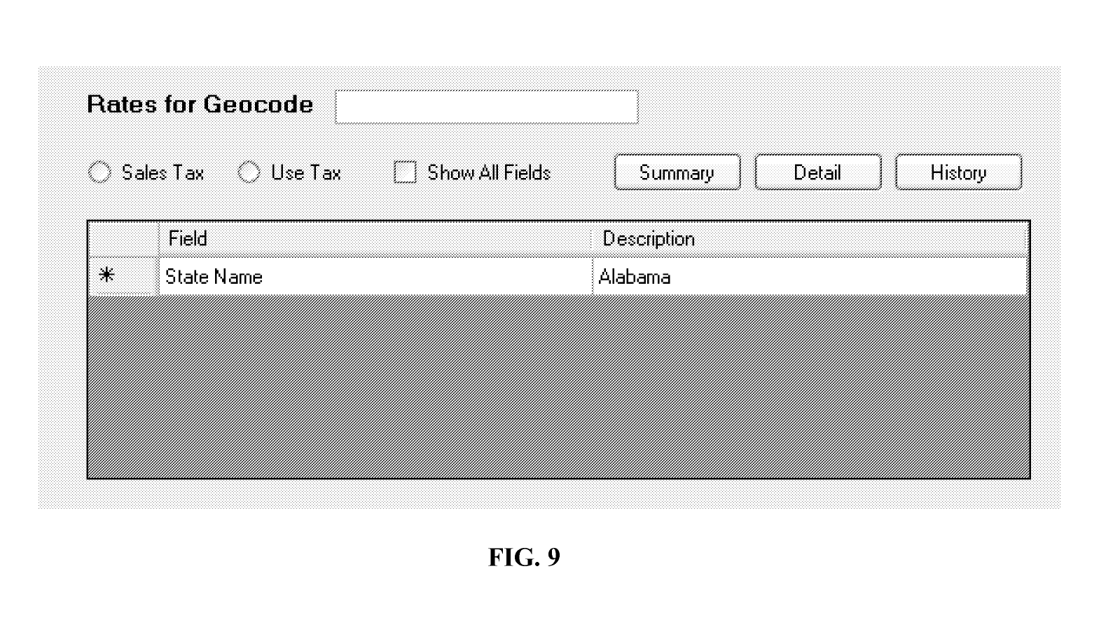

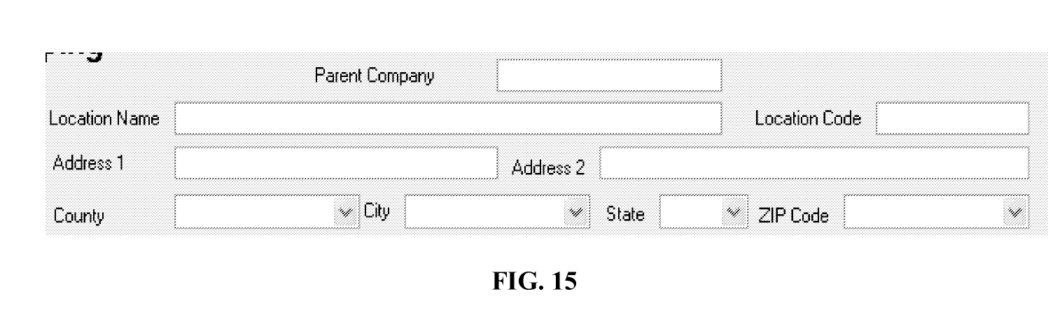

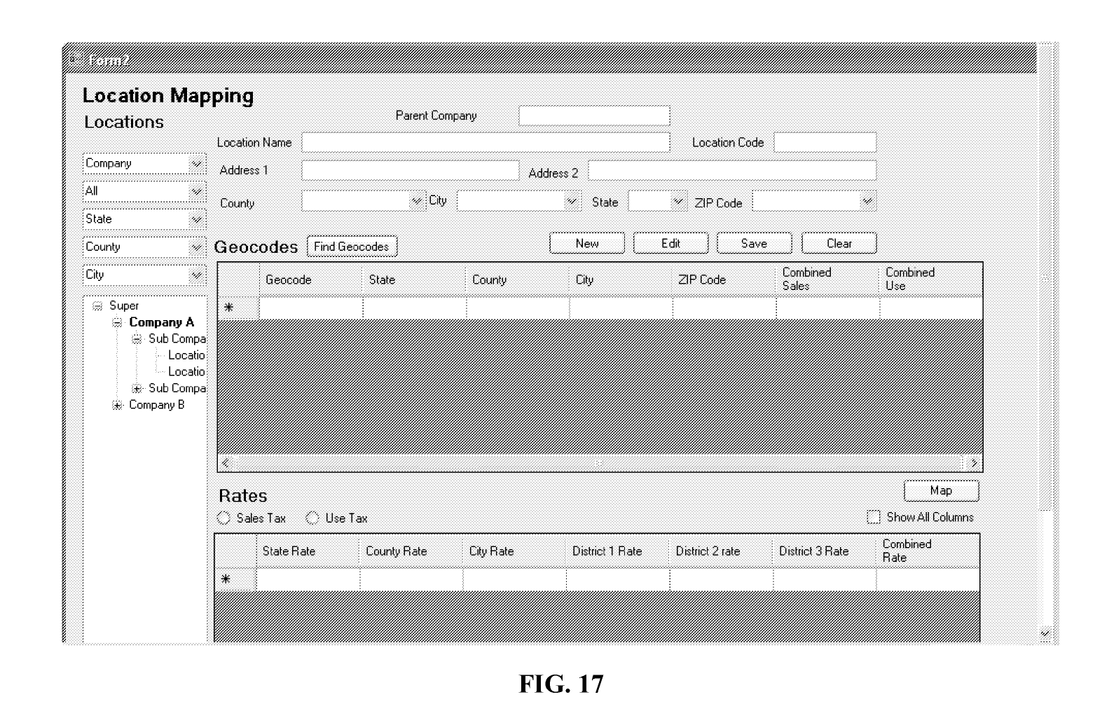

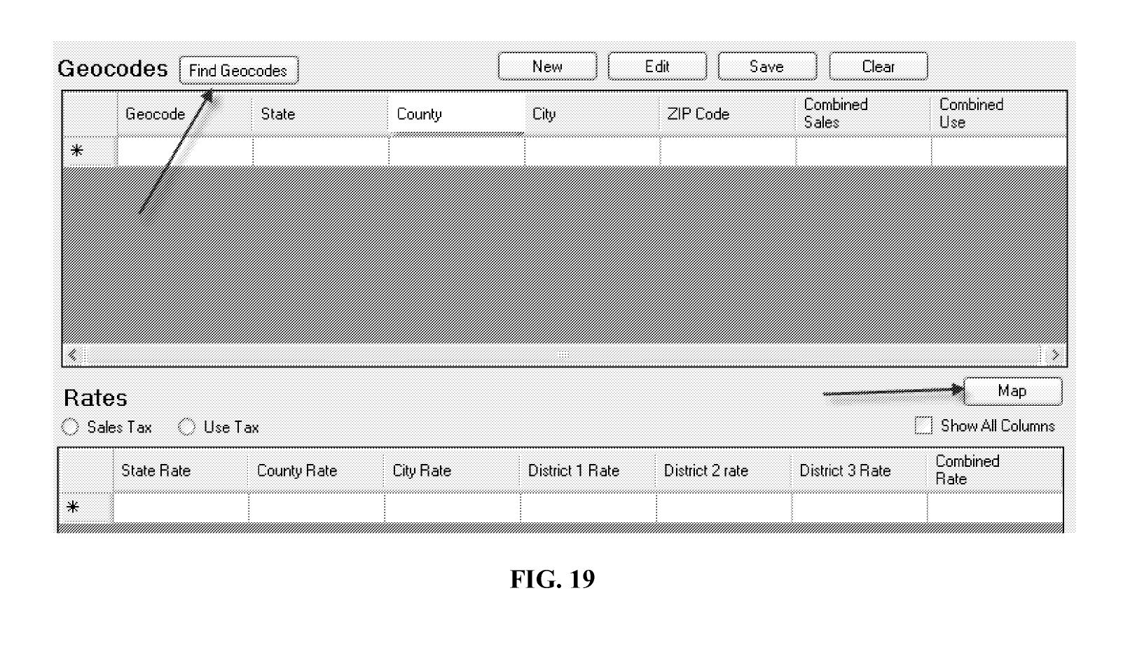

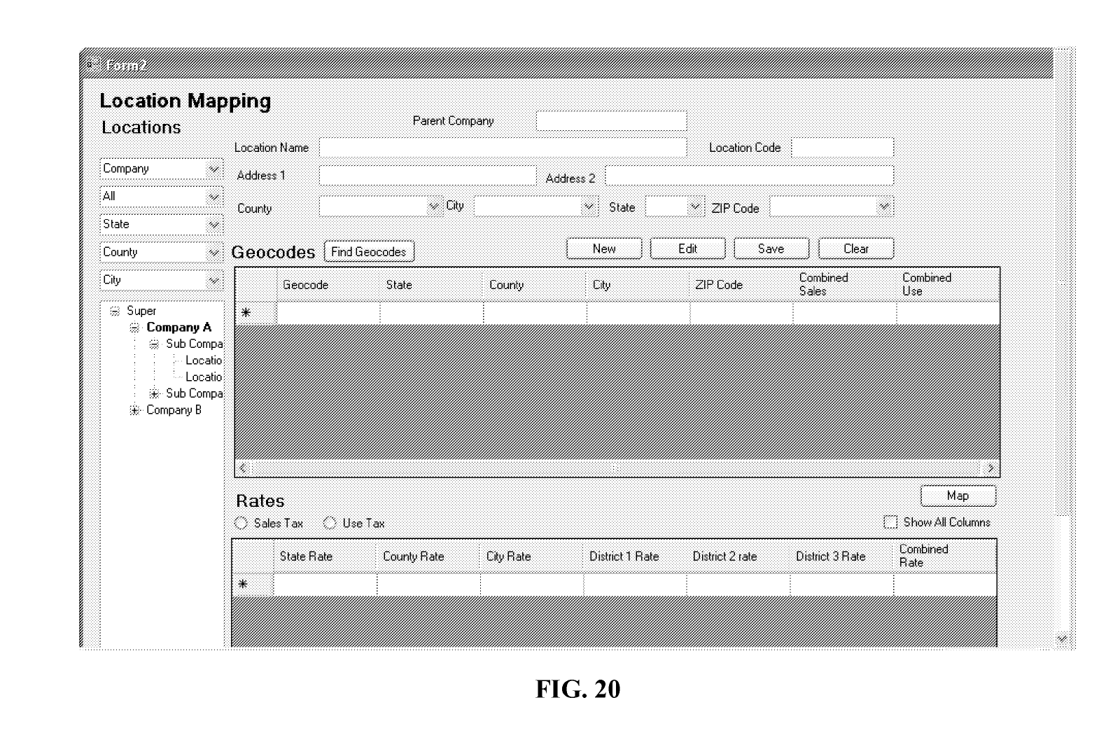

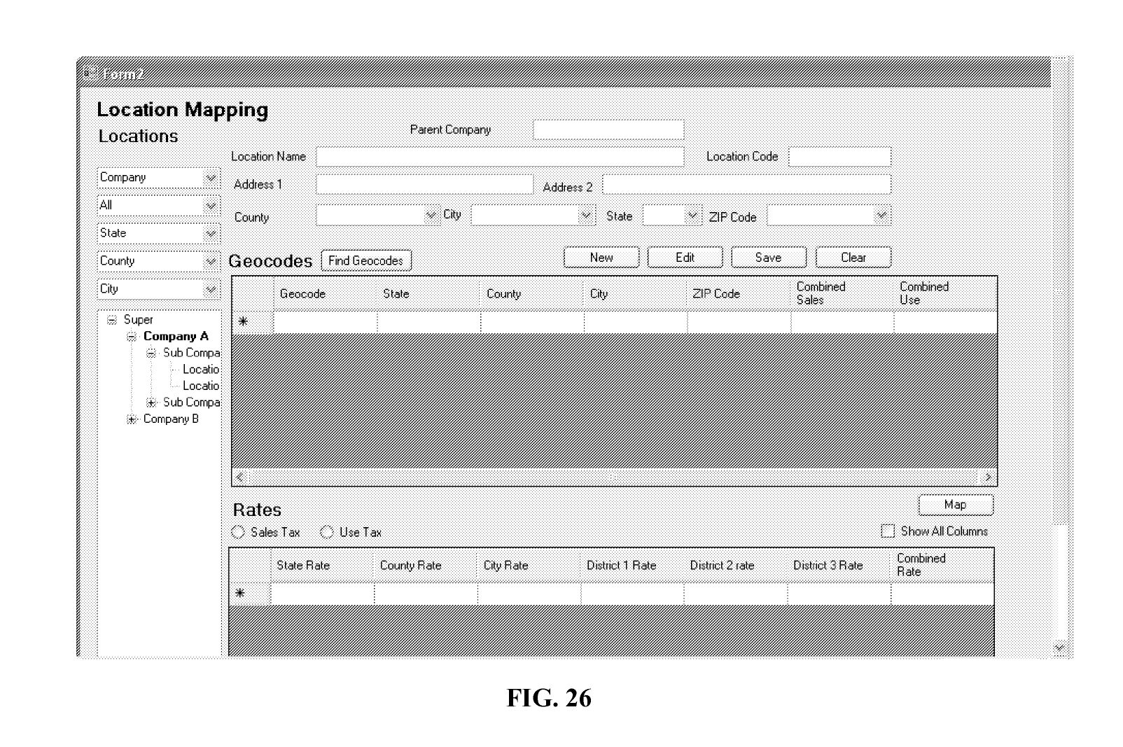

As described herein, in one embodiment, such as embodiment 250 illustrated in FIG. 2B, the client unit 210 can be embodied in a wireless device. In such embodiment, the client unit 210 can comprise a radio unit 254 that can permit wireless communication (e.g., reception and transmission) of information, a I/O interface 256, a processing unit 258 (also referred to as a processor), a rendering unit 260 to convey (visually and/or aurally) various of the graphical user interfaces (GUIs) described herein (e.g., FIG. 6-FIG. 27), and a memory 216. In one aspect the radio unit 254 can comprise a wireless transceiver having at least one antenna and circuitry suitable for processing wireless signal. Depending on available antennas, the wireless transceiver can operate in various communication modes, such as single-input single-output (SISO), multiple-input multiple-output (MIMO), and/or multiple-input single output (MISO). In one aspect, the wireless transceiver can communicate information (e.g., data, metadata, and/or signaling) according to one or more standardized radio technology (e.g., WiFi), including point-to-point communication. In one aspect, the processing unit 122 can process data and/or signaling and can be configured by a set of one or more computer-accessible (e.g., computer-executable and computer-readable) instructions that can be retained in the memory 216. Such computer-accessible instructions can be retained in a set of one or more memory elements 262, labeled as location-based tax information acquisition instruction(s) 262. It is noted that such instruction, in response to execution by the processing unit 258, can permit the client unit 210 to operate in accordance with one or more aspects of tax information acquisition and management described herein. In one aspect, the memory 130 can comprise non-volatile memory capable of a large number of rewrites and long data retention times.

In certain embodiments, the processing unit 258 and the I/O interface 256 can provide at least one of the GUIs described herein. In one aspect, the processing unit 258 can execute at least a portion of the location-based tax information acquisition instruction(s) 262 and can cause the I/O interface 256 to render at least one of the GUIs disclosed herein. In addition or in the alternative, execution of such instructions by the processing unit 258 can provide the disclosed functionality associated with location-based tax information acquisition and management to the client unit 210 in accordance with one or more aspects of the disclosure.

In general, the processing unit 258 can refer to any computing processing unit or processing device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally or alternatively, a processor 303 or processing unit 303 can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processor 303 or processing unit 303 also can be implemented as a combination of computing processing units.

Memory 216 can comprise a variety of computer readable media. Exemplary readable media can be any available media that is accessible by the processing unit 258 and/or the I/O interface 256 and comprises, for example, both volatile and non-volatile media, removable and non-removable media. The memory 216 can comprise computer readable media in the form of volatile memory, such as random access memory (RAM), and/or non-volatile memory, such as read only memory (ROM). In certain implementations, the memory 216 can contain information (e.g., data and/or metadata) and/or program modules for operation of the client unit 210 in response to execution of such modules.

In another aspect, the memory 216 can comprise other removable/non-removable, volatile/non-volatile computer storage media. The memory 216 can provide non-volatile storage of computer code (e.g., computer-executable instructions), computer-readable instructions, data structures, program modules, and other data for operation of the client unit 210. Depending on complexity and/or cost constraints for the device 210, the memory 216 can be a hard disk, a removable magnetic disk, a removable optical disk, magnetic cassettes or other magnetic storage devices, flash memory cards, optical storage, random access memories (RAM), read only memories (ROM), electrically erasable programmable read-only memory (EEPROM), and the like.

As it can be readily appreciated, in one embodiment, a system for location-based tax rate acquisition and management can monitor static locations for changes to one or more of tax rates and/or or boundaries to tax jurisdictions. For example, in the example system 100, the A&M server 110 can comprise a monitoring component (not shown) that can identify a specific location, and associated tax jurisdiction, as provided by the geospatial engine 130, and can acquire tax rates, or other tax information, at predetermined time intervals (e.g., periodic intervals, scheduled intervals, etc.). The tax rates, or the other tax information can be acquired (e.g., received, retrieved, or the like) from a source of tax information (not shown). It should be appreciated that the I/O interface 120 and the rendering unit 260, for example, in response to execution of a plurality of computer-accessible instructions retained in memory 140 or contained in the A&M server 110, can provide at least one GUI that permits accessing updated tax information. For another example, in the example system 200, client unit 210, via at least the I/O interface 212, can permit tracking tax rates, or other tax information, for a specific location, or tax jurisdiction. It should be appreciated that the specific location or tax jurisdiction can be configurable by an end-user of the client unit 210 or the A&M server 110. The particular tax rate (e.g., a prescription drug tax rate) that is monitored also can be monitored as described herein. Accordingly, the disclosure permits tracking of a user-defined tax rates.

In other embodiments, a system that implements location-based tax rate acquisition can be accessed by transaction in real-time or nearly real-time to return a tax rate and associated jurisdictional information. In one of such embodiments, the A&M server 110 can track the value of a transaction counter component (also referred to as transactional counter; not shown) which can be integrated into the A&M server 110 or functionally coupled thereto. Similarly, in an additional or alternative embodiment, the transaction counter component can be network-based, being integrated into the A&M server 240 or functionally coupled thereto.

One embodiment of the disclosure can include an example system that can supply location-based tax rates in accordance with one or more aspects described herein, and can be utilized with a web browser. The example system can be multi-tenant, role-based system that can be secured based at least on credentials (such as username and password) or other secure-access protocols (e.g., Authentication, Authorization, and Accounting (AAA) protocols, Remote Authentication Dial In User Service (RADIUS) protocol, or Diameter, Kerberos, or the like). In one aspect, administrative and end-user functions can define one or more actions that an agent (e.g., an end-user device or other machine, such as a client computer) can be permitted to perform within the example system. Performing at least one (e.g., one, two, more than two) or each of the one or more actions can result in a specific service associated with the location-based tax rate acquisition. In one aspect, the example system (e.g., example system 100) can include a database (e.g., tax information storage 146) that can comprise tax rate data for sales and use taxes in the United States and Canada. It should be appreciated that, as described herein, the embodiments that can support multi-tenancy can accommodate multiple users with different levels of access permission. In one scenarios, such users being prevented from accessing each other's data associated with tax rates and related locations. In one aspect, in example system 200, the repository 140 can retain one or more end-user credentials in one or more memory elements 242. Such credentials can permit access—according to the various secure-access protocols described herein—to functionality of the A&M server 240 based on pre-configured access privileges for one or more end-users or agents.

It is to be appreciated that the database (e.g., tax information storage 146) can include tax rates for substantially any type of tax rates, such as specialty taxes (e.g., liquor tax), prescription drug tax rates, or the like. It should also be appreciated that the database (e.g., tax information storage 146) is not restricted to including tax rates for the United States or Canada, and data associated with taxation regulations of most any geographic or geopolitical area can be contained in the database. In one aspect, as described herein, tax information (e.g., data and/or metadata associated with tax rates, tax jurisdictions, and the like) contained in the database (e.g., tax information storage 146) can be updated periodically (e.g., daily, weekly, monthly, annually, and so forth), according to a schedule, or in response to an event (such as a change in the tax code). In certain implementations, the A&M server 110 can update (e.g., delete, augment, revise, etc.) in accordance with one or more aspects described herein.

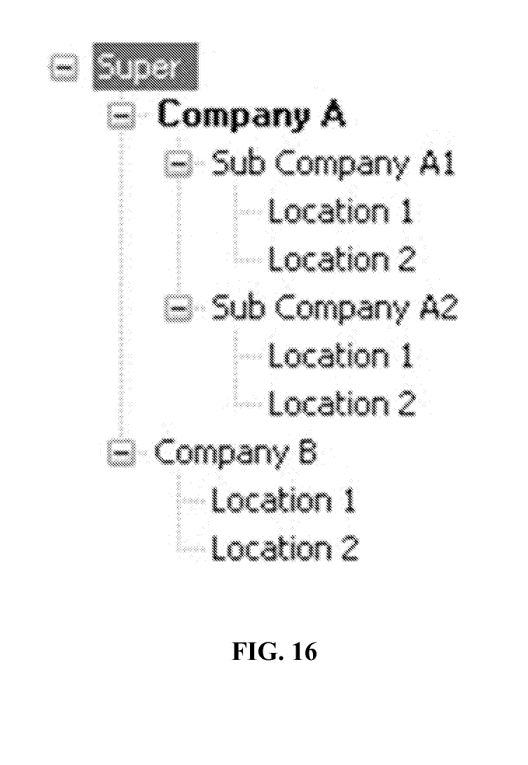

It should be appreciated that, in one aspect, certain embodiments of systems and methods of the disclosure can automate conventional methodologies and thus reduce or avoid the likelihood of errors associated with human intervention. Various exemplary systems described herein, such as example system 100, can exploit the concept of hierarchical structures that permit the creation of companies and sub-companies associated with a commercial entity or another relevant entity obligated to pay taxes. In one embodiment, the information retained in the tax information storage 146 and/or the location information retained in the location data structure(s) 142 can be arranged (or configured) as one or more hierarchical data structures. In such embodiment, a company and one or more related sub-companies can be form a hierarchical data structure for which tax information and location information can be configured as a hierarchical structure (see, e.g., FIG. 16) Each company (e.g., company A and company B in FIG. 16) and/or sub-company (e.g., sub-company A1 and/or sub-company A2 in FIG. 16) can access (e.g., load, acquire) locations that are associated with the relevant entity (e.g., either the company or the sub-company). In one aspect, during the load process a file (or other data container) can be selected that conforms to system specifications (e.g., specific file format) and can include various amounts of descriptive data representative of the locations (state, city, county, ZIP code, street, unique identity (ID), latitude, longitude, elevation, information indicative of being inside or outside city limits, combinations thereof, and so forth).

One example system of the subject disclosure can implement native functionality that can exploit “chopping” logic described herein in order to determine an appropriate geocode for each location in response to importing the descriptive data representative of the location. The richer (or more descriptive) the supplied data is, the higher the likelihood of finding a match is, with the ensuing increased likelihood of determining the appropriate geocode. In particular implementations, the example system (e.g., system 100 or example system 300) may not be configured to determine natively whether a street address is inside or outside of city limits for tax purposes (e.g., inside or outside a tax jurisdiction). For example, an information package having data indicative of taxation boundaries may not be available (e.g., persisted) in a memory (e.g., repository 140) functionally coupled to the example system. Therefore, in one implementation, absence of information (e.g., data or metadata) indicative of a location being outside of city limits can result in the location being assumed to be inside city limits To at least such end, in one aspect, the A&M server 110 can configure a specific location as a location inside of the city limits in response to data indicative of the specific location being

In one of such particular implementations or other implementations, the example system can autonomously learn, from historical data, for example, whether a position is outside of city limits or not. In a scenario in which the example system is embodied in or can comprise example system 300, an autonomous learning unit 310 can implement (e.g., configure, execute, configure and execute) one or more artificial intelligence (AI) techniques, such as machine learning and iterative learning, in order to draw a conclusion, or autonomously learn, if a specific location is inside or outside of a specific tax jurisdiction. In one aspect, as described herein, the historical data can form a training dataset, and can comprise historical associations between a location and a tax jurisdiction, wherein such association can be resolved by various approaches. Examples of such techniques include, but are not limited to, expert systems, case based reasoning, Bayesian networks, behavior based AI, neural networks, fuzzy systems, evolutionary computation (e.g., genetic algorithms), swarm intelligence (e.g., ant algorithms), and hybrid intelligent systems (e.g., Expert inference rules generated through a neural network or production rules from statistical learning).

In a related aspect, it is noted that there are several states in the United States that have “special” partial tax jurisdictions. Such tax jurisdictions do not conform to county or municipal boundaries. Accordingly, the example system (e.g., example system 300) may not be configured to establish automatically whether or not a location is inside or outside of one of such partial tax jurisdictions. As a result, in one aspect, those locations can be accessed (e.g., imported) as “unmapped.” In one aspect, the example system can supply (e.g., render on a display unit or other device (mobile or otherwise)) an option to select a geocode from several possibilities in order to generate a “mapping” (or an association) between an unmapped location and a geocode. In one aspect, after the unmapped location is mapped in response to selection of a specific geocode, the location can be tracked at subsequent times in realtime, nearly realtime, or according to a schedule. It should be noted that conventional solutions for tax rate lookup generally do not automatically assign jurisdictions to stored locations nor leverage a system or a methodology for performing such assignment. For example, the location can be mapped by the A&M server 240 in response to a command received from the client unit 210 and, in response to such mapping, the A&M server 240 can track the location and assign suitable tax jurisdictions (e.g., tax jurisdiction resolved by the geospatial engine 220).

In certain embodiments, coupling a system for location-based tax rate acquisition with a geospatial engine can enable automated determination of whether or not a location is inside or outside city limits or a partial tax jurisdiction. As described herein, for example, the autonomous learning unit 310 can infer and, thus, determine whether a specific location is inside or outside city limits or a partial tax jurisdiction. Conventionally, in a variety of scenarios, geospatial engines have primarily been utilized with full tax calculation engines or with a tax rate determination service. Yet, in such scenarios, conventional systems typically do not store locations nor monitor them for changes in tax jurisdiction boundaries. Accordingly, conventional systems do not achieve any efficiencies from, and thus do not benefit from, creating hierarchical company structures utilized to store such locations and to enable multi-tenancy. In one implementation, the disclosed systems and methods for location-based tax rates can produce output for all changes to all locations with one or more actions executed in response to a single request that can then be uploaded into a desired end-user's system. Such example functionality is one of the unique features of the disclosure.

In certain embodiments, a risk-report (which can be contained in the report 128) can be generated for locations that are accessed (e.g., loaded or otherwise acquired) and characterized as being within city limits. In one aspect, such report can identify locations mapped to jurisdictions that have a city tax. In another aspect, the risk-report can quantify the risk of improper tax obligations for such mappings, for example, by conveying the number of locations that may be erroneously attributed an incorrect (e.g., higher or lower) tax rate. It should be appreciated that, in one aspect, availability of such report can effectively address the issue of most large companies not being certain if a specific location is inside or outside of an incorporated location for tax purposes. In one example embodiment, the risk report can be generated by the A&M server 110. In another example embodiment, the risk report can be generated by the A&M server 140.

One or more of the disclosed systems can exploit historical tax rate data available in databases integrated with (e.g., tax information storage 146) or functionally coupled to such systems in order to analyze (e.g., data mine) such data for locations and or groups of transactions within a specific time period. Such information can be leveraged, among other things, in audit defense and audit recovery activities.

One or more embodiments of the subject disclosure (e.g., example system 100 or example system 200) can implement various other functionalities, including one or more of the following example functionalities: (I) validation of rates upon import—load one of rates associated with a location or historical sales/ordering transactions that carried a tax rate, and validate the rate in effect for the location and/or transaction—for the relevant time period; (II) calendar controls including historical searches by date ranges; (III) look up rates for a specific time period by jurisdiction; or (IV) modular licensing by content type—tax rate types other than standard sales and use tax rates are contemplated for use. For instance, prescription drug rates for various geographical or geopolitical areas (e.g., state of Illinois, state of Missouri, state of Louisiana) can be incorporated in one or more of the embodiments of the disclosure. It should be appreciated that the disclosed systems and method can be extensible, and other specialty tax rates (e.g., liquor, prepared foods, calling cards, etc.) can be incorporated based on implementation needs or as such rates are instated. Various embodiments can have modular licensing of the content by jurisdiction and/or tax type (e.g., specific content).

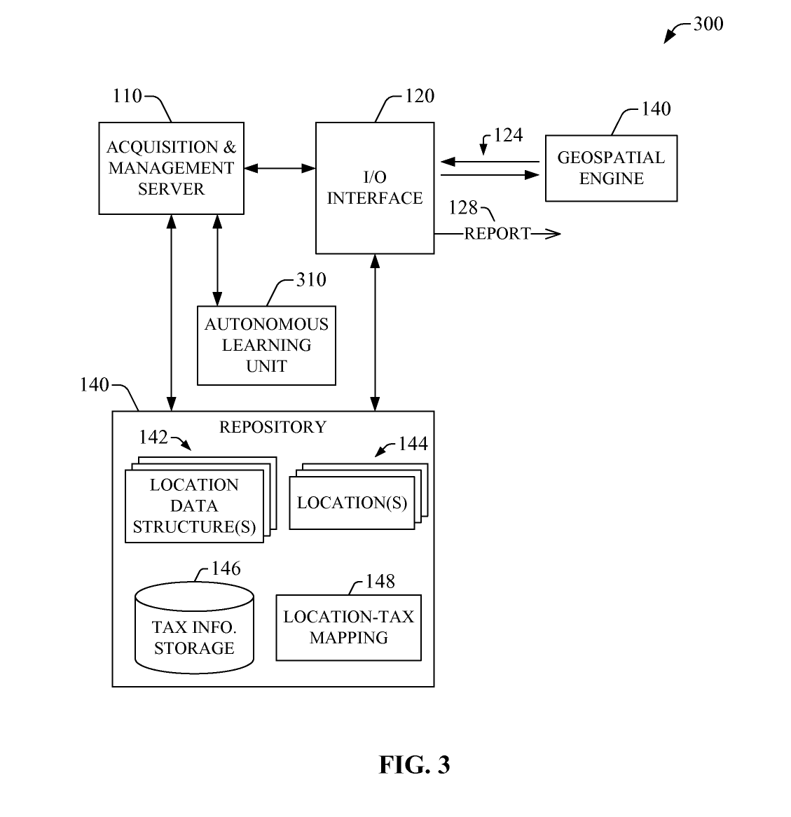

FIG. 4 is a block diagram that illustrates an exemplary operating environment 400 that enables features of the disclosure and performance of the methods disclosed herein. This exemplary operating environment is only an example of an operating environment and is not intended to suggest any limitation as to the scope of use or functionality of operating environment architecture. Neither should the operating environment be interpreted as having any dependency or requirement relating to any one or combination of functional elements illustrated in the exemplary operating environment.

The various embodiments of the subject disclosure can be operational with numerous other general purpose or special purpose computing system environments or configurations. Examples of well known computing systems, environments, and/or configurations that can be suitable for use with the systems and methods comprise, but are not limited to, personal computers, server computers, laptop devices or handheld devices, and multiprocessor systems. Additional examples comprise wearable devices, mobile devices, set top boxes, programmable consumer electronics, network PCs, minicomputers, mainframe computers, distributed computing environments that comprise any of the above systems or devices, and the like. In one embodiment, the computing device 401 can embody the A&M server 110. In another embodiment, the computing device 401 can embody the combination of the A&M server 110 and the I/O interface 120. In yet another embodiment, the computing device 401 can embody the A&M server 240. In still another embodiment, the computing device 401 can embody the client unit 210—in this embodiment, the input/output interface 410 can include radio unit 254.

The processing effected in the disclosed systems and methods can be performed by software components. The disclosed systems and methods can be described in the general context of computer-executable instructions, such as program modules, being executed by one or more computers or other computing devices. Generally, program modules comprise computer code, routines, programs, objects, components, data structures, etc. that perform particular tasks or implement particular abstract data types. The disclosed methods also can be practiced in grid-based and distributed computing environments where tasks are performed by remote processing devices that are linked through a communications network. In a distributed computing environment, program modules can be located in both local and remote computer storage media including memory storage devices.

Further, the systems and methods disclosed herein can be implemented via a general-purpose computing device in the form of a computing device 401. The components of the computing device 401 can comprise, but are not limited to, one or more processors 403, or processing units 403, a system memory 412, and a system bus 413 that couples various system components including the processor 403 to the system memory 412. In the case of multiple processing units 403, the system can utilize parallel computing.

In general, a processor 403 or a processing unit 403 refers to any computing processing unit or processing device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally or alternatively, a processor 403 or processing unit 403 can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processor 403 or processing unit 403 also can be implemented as a combination of computing processing units.

The system bus 413 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 413, and all buses specified in this description also can be implemented over a wired or wireless network connection and each of the subsystems, including the processor 403, a mass storage device 404, an operating system 405, location-based tax rate acquisition software 406, location-based tax rate acquisition data 407, a network adapter 408, system memory 412, an Input/Output Interface 410, a display adapter 409, a display device 411, and a human machine interface 402, can be contained within one or more remote computing devices 414a,b,c at physically separate locations, connected through buses of this form, in effect implementing a fully distributed system. Remote computing devices 414a,b,c can be user equipment (e.g., a mobile device or a wearable device) or customer premises equipment (e.g., an office network server, a desktop computer, or the like).

In one aspect, location-based tax rate acquisition data 407 can comprise tax rate and related jurisdictional information. In another aspect, the location-based tax rate acquisition data 407 also can comprise location information, and information about the tax rate. As an illustration, information retained in location-based tax rate acquisition data can include one or more of rate details (e.g., all levels of tax rate, such as state, county, city, special, split rates, thresholds, max tax rates, taxing authorities, aggregate rate, etc), location, and date data (e.g., effective date, historical dates, etc.). Such information can be represented by various data elements that represent the information in memory element 407 and conveys suitable data such as geocode; effectiveDateString; ZIP; stateName; stateSalesRate1; stateSalesMinimum1; stateSalesMaximum1; stateSalesSplitAmount1; stateSplitSalesRate1; stateSalesMaxTaxAmount1; stateSalesRate2; stateSalesMinimum2; stateSalesMaximum2; stateSalesSplitAmount2; stateSalesSplitRate2; stateSalesMaxTaxAmount2; stateSalesRate3; stateSalesMinimum3; stateSalesMaximum3; stateSalesSplitAmount3; stateSalesSplitRate3; stateSalesMaxTaxAmount3; stateUseRate1; stateUseMinimum1; stateUseMaximum1; stateUseSplitAmount1; stateSplitUseRate1; stateUseMaxTaxAmount1; stateUseRate2; stateUseMinimum2; stateUseMaximum2; stateUseSplitAmount2; stateUseSplitRate2; stateUseMaxTaxAmount2; stateUseRate3; stateUseMinimum3; stateUseMaximum3; stateUseSplitAmount3; stateUseSplitRate3; stateUseMaxTaxAmount3; countyName; countySalesRate1; countySalesMinimum1; countySalesMaximum1; countySalesSplitAmount1; countySplitSalesRate1; countySalesMaxTaxAmount1; countySalesRate2; countySalesMinimum2; countySalesMaximum2; countySalesSplitAmount2; countySalesSplitRate2; countySalesMaxTaxAmount2; countySalesRate3; countySalesMinimum3; countySalesMaximum3; countySalesSplitAmount3; countySalesSplitRate3; countySalesMaxTaxAmount3; countyUseRate1; countyUseMinimum1; countyUseMaximum1; countyUseSplitAmount1; countySplitUseRate1; countyUseMaxTaxAmount1; countyUseRate2; countyUseMinimum2; countyUseMaximum2; countyUseSplitAmount2; countyUseSplitRate2; countyUseMaxTaxAmount2; countyUseRate3; countyUseMinimum3; countyUseMaximum3; countyUseSplitAmount3; countyUseSplitRate3; countyUseMaxTaxAmount3; cityName; citySalesRate1; citySalesMinimum1; citySalesMaximum1; citySalesSplitAmount1; citySplitSalesRate1; citySalesMaxTaxAmount1; citySalesRate2; citySalesMinimum2; citySalesMaximum2; citySalesSplitAmount2; citySalesSplitRate2; citySalesMaxTaxAmount2; citySalesRate3; citySalesMinimum3; citySalesMaximum3; citySalesSplitAmount3; citySalesSplitRate3; citySalesMaxTaxAmount3; cityUseRate1; cityUseMinimum1; cityUseMaximum1; cityUseSplitAmount1; citySplitUseRate1; cityUseMaxTaxAmount1; cityUseRate2; cityUseMinimum2; cityUseMaximum2; cityUseSplitAmount2; cityUseSplitRate2; cityUseMaxTaxAmount2; cityUseRate3; cityUseMinimum3; cityUseMaximum3; cityUseSplitAmount3; cityUseSplitRate3; cityUseMaxTaxAmount3; stj1Name; stj1SalesRate1; stj1UseRate1; stj2Name; stj2SalesRate1; stj2UseRate1; stj3Name; stj3SalesRate1; stj3UseRate1; stj4Name; stj4SalesRate1; stj4UseRate1; stj5Name; stj5SalesRate1; stj5UseRate1; combinedSalesTaxRate; combinedUseTaxRate; sdCode; historyFlag; defaultCity; changeIndicator; stateTaxAuthority; countyTaxAuthority; cityTaxAuthority; stj1TaxAuthority; stj2TaxAuthority; stj3TaxAuthority; stj4TaxAuthority; stj5TaxAuthority; unincorporatedArea; vertical; mailingAddress; reportingCity. In one aspect, the “historyFlag” identifier can determine if a new tax record and/or location record is to be made part of historical data as described herein. In another aspect, identifiers such as “stateSalesSplitAmount1” and “stateSplitSalesRate1” refer to split tax rates, in which a specific first tax rate is applied to a first amount of a total amount and at least a specific second tax rate is applied to a second amount of the total amount.

The computing device 401 typically comprises a variety of computer readable media. Exemplary readable media can be any available media that is accessible by the computing device 401 and comprises, for example and not meant to be limiting, both volatile and non-volatile media, removable and non-removable media. The system memory 412 comprises computer readable media in the form of volatile memory, such as random access memory (RAM), and/or non-volatile memory, such as read only memory (ROM). The system memory 412 typically contains data (such as a group of tokens employed for code buffers) and/or program modules such as operating system 405 and location-based tax rate acquisition software 406 that are immediately accessible to and/or are presently operated on by the processor 403. Operating system 405 can comprise OSs such as Windows operating system, Unix, Linux, Symbian, Android, iOS, Chromium, and substantially any operating system for wireless computing devices or tethered computing devices.

In another aspect, the computing device 401 also can comprise other removable/non-removable, volatile/non-volatile computer storage media. By way of example, FIG. 4 illustrates a mass storage device 404 which can provide non-volatile storage of computer code, computer readable instructions, data structures, program modules, and other data for the computing device 401. For example and not meant to be limiting, a mass storage device 404 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 404, including by way of example, an operating system 405, and location-based tax rate acquisition software 406. Each of the operating system 405 and location-based tax rate acquisition software 406 (or some combination thereof) can comprise elements of the programming and the location-based tax rate acquisition software 406. Data and code (e.g., computer-executable instruction(s)) can be retained as part of location-based tax rate acquisition software 406 and can be stored on the mass storage device 404. Location-based tax rate acquisition software 406, and related data and code, can be stored in any of one or more databases known in the art. Examples of such databases comprise, DB2®, Microsoft® Access, Microsoft® SQL Server, Oracle®, mySQL, PostgreSQL, and the like. Further examples include membase databases and flat file databases. The databases can be centralized or distributed across multiple systems.

In another aspect, the user can enter commands and information into the computing device 401 via an input device (not shown). Examples of such input devices comprise, but are not limited to, a camera; a keyboard; a pointing device (e.g., a “mouse”); a microphone; a joystick; a scanner (e.g., barcode scanner); a reader device such as a radio frequency identification (RFID) readers or magnetic stripe readers; gesture-based input devices such as tactile input devices (e.g., touch screens, gloves and other body coverings or wearable devices), speech recognition devices, or natural interfaces; and the like. These and other input devices can be connected to the processing unit 403 via a human machine interface 402 that is coupled to the system bus 413, but can be connected by other interface and bus structures, such as a parallel port, game port, an IEEE 1394 Port (also known as a Firewire port), a serial port, or a universal serial bus (USB).

In yet another aspect, a display device 411 also can be connected to the system bus 413 via an interface, such as a display adapter 409. It is contemplated that the computing device 401 can have more than one display adapter 409 and the computing device 401 can have more than one display device 411. For example, a display device can be a monitor, an LCD (Liquid Crystal Display), or a projector. In addition to the display device 411, other output peripheral devices can comprise components such as speakers (not shown) and a printer (not shown) which can be connected to the computing device 401 via Input/Output Interface 410. Any step and/or result of the methods can be output in any form to an output device. Such output can be any form of visual representation, including, but not limited to, textual, graphical, animation, audio, tactile, and the like.

The computing device 401 can operate in a networked environment using logical connections to one or more remote computing devices 414a,b,c. By way of example, a remote computing device can be a personal computer, portable computer, a mobile telephone, a server, a router, a network computer, a peer device or other common network node, and so on. Logical connections between the computing device 401 and a remote computing device 414a,b,c can be made via one or more access network(s) comprising wireline or wireless networks, which can include wide area networks (WANs), wireless WANs (WWANs), local area networks (LANs), wireless LANs (WLANs), signaling networks (e.g., SS#7), etc.), and so forth. In addition, such networks can operate in accordance with any or most any communication protocol. Such network connections can be through a network adapter 408. A network adapter 408 can be implemented in both wired and wireless environments. Such networking environments are conventional and commonplace in offices, enterprise-wide computer networks, intranets, and general-purpose telecommunication network(s) 415 (e.g., the internet). Networking environments generally can be embodied in wireline networks or wireless networks (e.g., cellular networks, such as Third Generation (3G) and Fourth Generation (4G) cellular networks, facility-based networks (femtocell, picocell, Wi-Fi networks, etc.).

In an exemplary embodiments, remote computing device 414a can be a mobile device that can determine its physical position by collecting global positioning system (GPS) location data (e.g., a position fix) and can deliver data comprising data representative of the physical position to computing 401 via a radio transceiver or other data delivery interface. The data that can be delivered can include other information, such as city and state (e.g., Burlington, Mass.), ZIP code, county, effective date (present day, a specific historical date, a period of time, etc.) of tax rate, combinations thereof, or the like. In one aspect, the data representative of the physical position can be delivered as latitude and longitude, or latitude, longitude, and elevation. Computing device 401, via the processor 403, can execute at least a portion of the location-based tax rate acquisition software 406 and utilize location-based tax rate acquisition data (e.g., locations, geocodes, tax rates, jurisdiction boundaries, or the like) to generate one or more of a tax rate for the physical position; information about the tax rate, such as tax rate details, location (which can be complementary or supplementary to the data representative of the physical location), and date data or any other time stamp; or related information about a tax jurisdiction associated with the physical position. As described herein, the tax rate and related jurisdictional information, location information, and information about the tax rate can be retained as part of location-based tax rate acquisition data.

As an illustration, application programs and other executable program components such as the operating system 405 are illustrated herein as discrete blocks, although it is recognized that such programs and components reside at various times in different storage components of the computing device 401, and are executed by the data processor(s) of the computer. An implementation of location-based tax rate acquisition software 406 can be stored on or transmitted across some form of computer readable media. Any of the disclosed methods can be performed in response to execution of computer-readable computer-executable instructions embodied on computer readable media. Computer readable media can be any available media that can be accessed by a computer. By way of example and not meant to be limiting, computer-readable media can comprise “computer storage media,” or “computer-readable storage media,” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

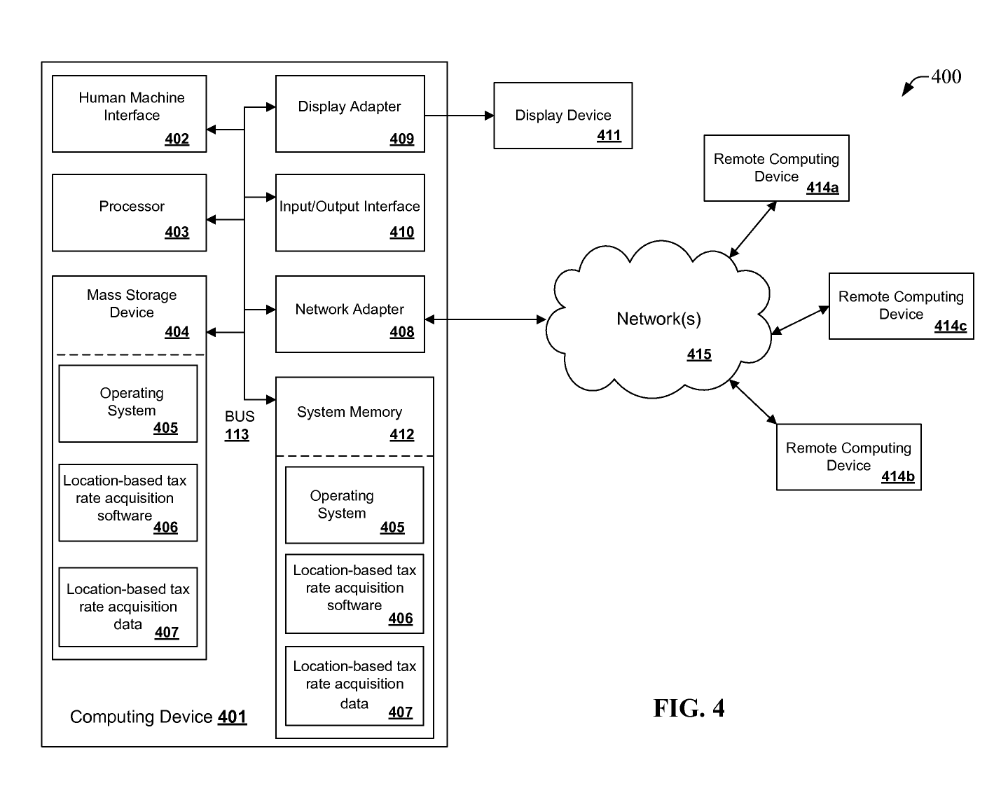

In view of the aspects described hereinbefore, an exemplary method that can be implemented in accordance with the disclosed subject matter can be better appreciated with reference to the flowchart in FIG. 5. For purposes of simplicity of explanation, the exemplary method disclosed herein is presented and described as a series of acts; however, it is to be understood and appreciated that the claimed subject matter is not limited by the order of acts, as some acts may occur in different orders and/or concurrently with other acts from that shown and described herein. For example, the various methods or processes of the subject disclosure can alternatively be represented as a series of interrelated states or events, such as in a state diagram. Moreover, when disparate functional elements implement disparate portions of the methods or processes in the subject disclosure, an interaction diagram or a call flow can represent such methods or processes. Furthermore, not all illustrated acts may be required to implement a method in accordance with the subject disclosure. Further yet, two or more of the disclosed methods or processes can be implemented in combination with each other, to accomplish one or more features or advantages herein described. It should be further appreciated that the exemplary methods disclosed throughout the subject specification can be stored on an article of manufacture, or computer-readable medium, to facilitate transporting and transferring such methods to computers for execution, and thus implementation, by a processor or for storage in a memory.

FIG. 5 is a flowchart of an exemplary method 500 for acquiring location-based tax rates in accordance with aspects of the subject disclosure. A computer or other computing device (mobile or otherwise) can perform the subject exemplary method. To at least such end, the computer or computing device can execute computer-executable instructions that embody an implementation of exemplary method 500. In one aspect, the computer or the computing device can perform exemplary method 500 in response to a transaction request to provide a tax rate and related jurisdictional information. In another aspect, the computer or the computing device can perform the subject exemplary method in an automated fashion, nearly continuously or according to a predetermined schedule.

At step 510, data representative of a location is received. In certain embodiments, the computer or computing device that performs the subject exemplary method can receive such data from a remote computing device (e.g., device 414a), which can be a mobile device or a tethered device. The mobile device or the tethered device can enable delivery of the data through various interfaces such as a data entry interface (keyboard, mouse, trackball, etc.); an interface operated in part based on gestures (motion, speech, touch, etc.); an interface configured to collect location data such as a global positioning system (GPS) receiver functionally coupled to a radio transceiver or other data delivery interface; or the like. The data representative of a location can be received through various access networks (e.g., network(s) 415).

At block 520, the location is associated to a data structure indicative of the location, the data structure being mapped to a tax jurisdiction. As described herein, the data structure can include FIPS codes; ZIP codes; latitude and longitude; latitude, longitude, and elevation; or the like. In one aspect, a mapping among the location and the tax jurisdiction can be dynamic, reflecting changes in spatial boundaries to the tax jurisdiction. At step 530, the tax jurisdiction associated with the data structure is identified. At step 540, a tax rate is assigned to the location based on the tax jurisdiction. In one aspect, the current tax rate is mapped to the tax jurisdiction.

At block 550, the current tax rate is supplied. In one aspect, supplying the tax rate can include generating and delivering a report comprising the tax rate to the remote device (e.g., the geospatial engine) that can provide the data representative of the location. In another aspect, the report can include information associated to the tax jurisdiction and historical data related to tax rates (e.g., previous tax rates for the tax jurisdiction) and jurisdictional information (e.g., changes in boundaries in tax jurisdictions). As described herein, the information can include rate details (e.g., some or all levels of tax rate, such as state, county, city, special, split rates, thresholds, max tax rates, taxing authorities, aggregate rate, etc), location, and date data (e.g., effective date, historical dates, etc.) or other time data. In addition or in the alternative, the information can comprise one or more updates to tax rates and/or boundaries of tax jurisdictions. For instance, the report can include one or more of names of locations for which a tax rate has changed, or differences in tax rates resulting from such updates. The report can be provided in a variety of formats and can be communicated to a variety of computing devices (wireless or otherwise).

In embodiments in which the data representative of the location is received through a mobile device, implementation of the example method 500 can exploit a user-device's physical position to produce a tax rate and related tax information, and return the tax rate, or the tax related information, or both, to the user device for a variety of purposes, for example, to apply tax to a mobile purchase, or for any other intended purposes.

In certain embodiments, blocks 520 through 550 can be performed in an automated cycle, or loop, and thus enable monitoring (or tracking) of tax rates for the location represented by the data received at block 510. In one aspect, such monitoring can reflect changes in tax rates (sales tax rate, use tax rate or other specialty tax rates, combinations thereof, or the like) associated with one or more of changes to value of tax rate for the tax jurisdiction, and/or changes in tax jurisdiction associated with the location resulting from changes in tax jurisdiction spatial boundaries.

FIGS. 6-27 illustrates various example features for tax information lookup and validation GUI(s), and related platform, that can be integrated into or can supplement or complement one or more of the various embodiments of systems and methods for location-based tax rate acquisition in accordance with one or more aspects described herein. The platform can be used to query tax rates in jurisdictions by current or historical dates as well as maintain and update rates of customer locations. This platform also can report on any changes to rates that customers have assigned to their locations.

### Acquisition Screen

In one aspect, the GUI presented in FIG. 6 can permit to query any jurisdiction and determine the correct tax rate either on a particular date or over an historical time period.

### Jurisdictions

Jurisdictions are the State, Counties and Cities in the US. In certain embodiments for location-based tax rate acquisition in accordance with the subject disclosure can store these jurisdictions by a combination of federal information processing standards (FIPS) codes (which are an exemplary embodiment of a Geocode) and ZIP Code. Other data structures indicative of a location also can be contemplated, e.g., latitude and longitude; latitude, longitude, and elevation; and so forth. An end-user device can input jurisdictions and/or a ZIP code retrieve Geocodes. Exemplary selection criteria can include:
State
County
City
ZIP Code

As an illustration, a system that implements the lookup functionality can return all geocodes for selected criteria. For example, if Massachusetts was the only criteria selected, all geocodes and rates that include Massachusetts can be returned. If the city of Boston was added to the criteria, only those Geocodes including Massachusetts and Boston can be returned.

### Tax Rates

An agent (e.g., end-user device, a client computer, . . . ) can then be able to select a single Geocode from the returned data set that is displayed below the filter. The Geocode that is selected can have the rates associated with it displayed below the Geocode display. The results of that second display are described herein. In one aspect, if an agent (e.g., end-user device, client computer, . . . ) selects a different geocode from the search grid, the rates can be updated in the lower grid.

Tax rates can be stored in a database so that they are associated to the Geocode. When an agent (e.g., end-user device, client computer, . . . ) selects a Geocode, all of the tax rates can be rendered for the agent to consume (e.g., for the end-user device to review). In one aspect, the data that is returned can be limited to the tax rates only. In another aspect, there are options associated with this screen that the agent can select. If the agent selects one of these options they need the ability to return to the main screen.

### Tax Rate Summary Option

The initial view can be limited to the tax rates from the selected jurisdictions. In certain implementations, there can be an option to view all the data associated with the tax rates which can render (e.g., display) any max tax or thresholds. This view can display the entire record. As an illustration, the screenshot below is updated to reflect the vertical display outlined in the wireframes that were provided.

### Tax Rate Detail Option

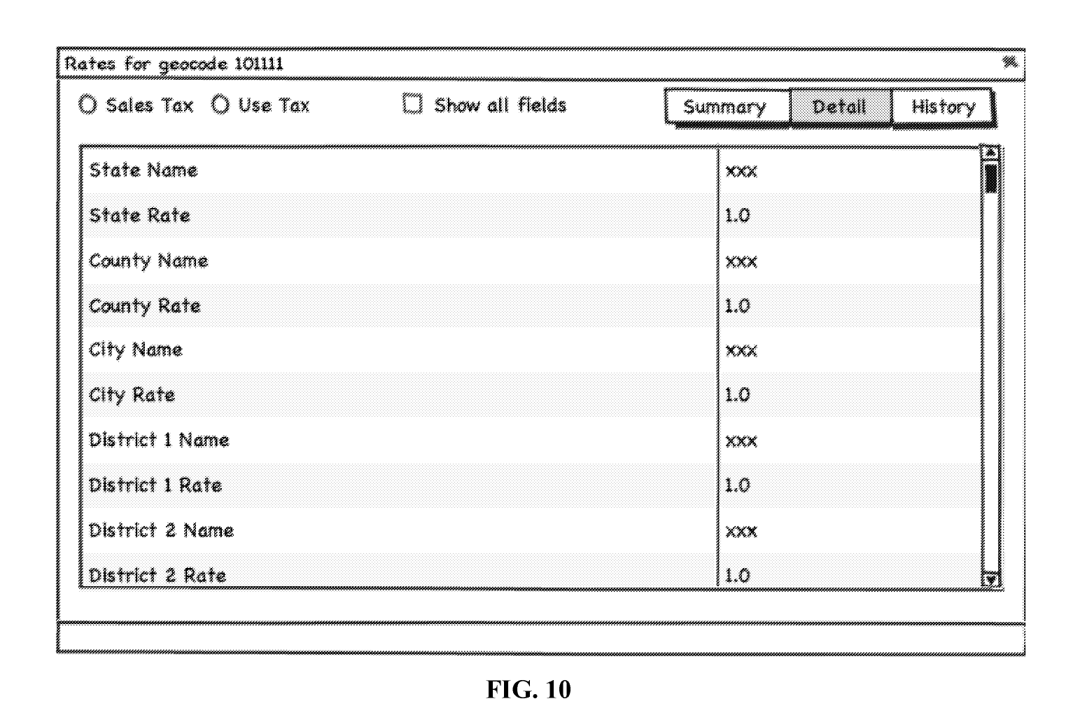

After selecting a geocode and rendering (e.g., displaying) the tax rate, a detail option that permits the agent to consume the breakdown by jurisdictions included in the Geocode can be available. The detail can display the name of the jurisdictions along with the current tax rate associated to it including valid districts and their names. The detail can have the all column option in FIG. 10 in order to bring in any max tax or threshold information associated to the jurisdiction. In certain implementations, a soft actuator (e.g., soft-button) can be available to toggle between Sales Tax rates and Use Tax rates so the agent can select the tax type to display.

### Tax Rate History Option

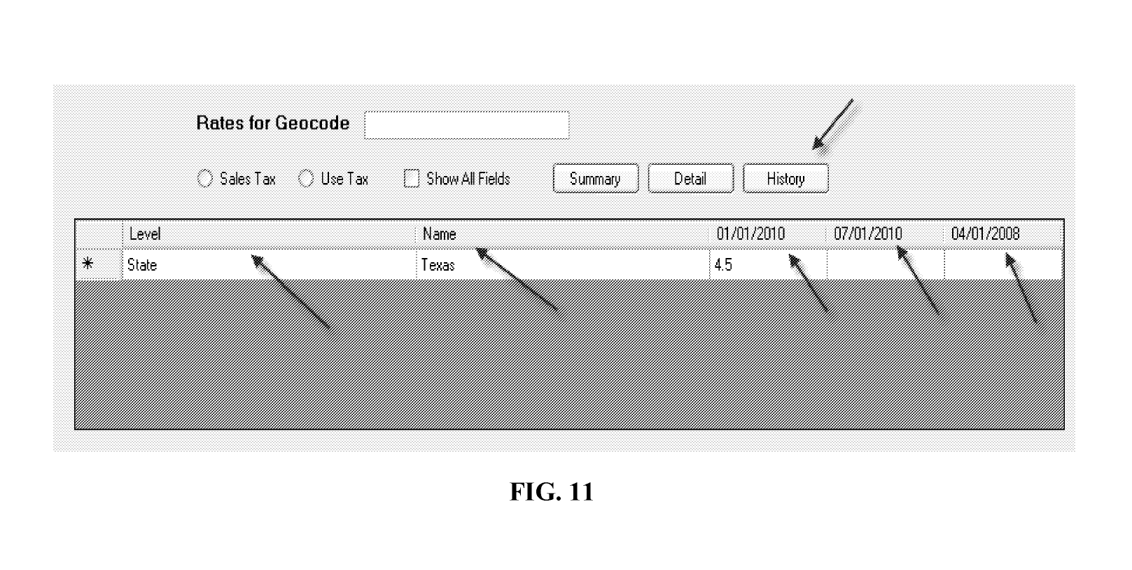

This option, illustrated in FIG. 11, can display substantially the same information as the detail option. The difference here can be that the column headers in the detail screen become the rows, and the columns are the effective dates for the tax rules associated to that Geocode. Jurisdictions can be displayed by row with effective dates being displayed in the columns The jurisdictions can be displayed with the State Name in the first row, County Name in the second row and so on throughout all of the jurisdictions. The effective dates can be ordered by the most current date in the first column followed by past dates in descending order. In certain implementations, a soft actuator (e.g., a soft-button) can be available to toggle between Sales Tax rates and Use Tax rates so the agent (an end-user device, a client computer, . . . ) can select the tax type to display.

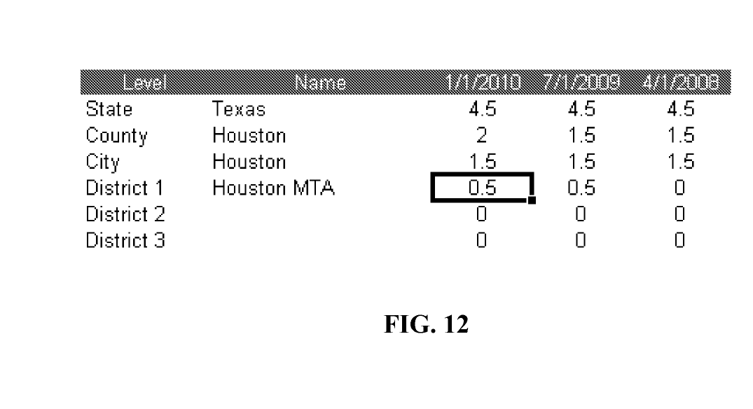

In one aspect, FIG. 11-12 convey the manner in which the history can be displayed. The grid is incomplete but below is a table that can represent what is to be populated within the display. The numbers in the columns under the dates represent the tax rates for the jurisdictions on that date.

### Map Location Option

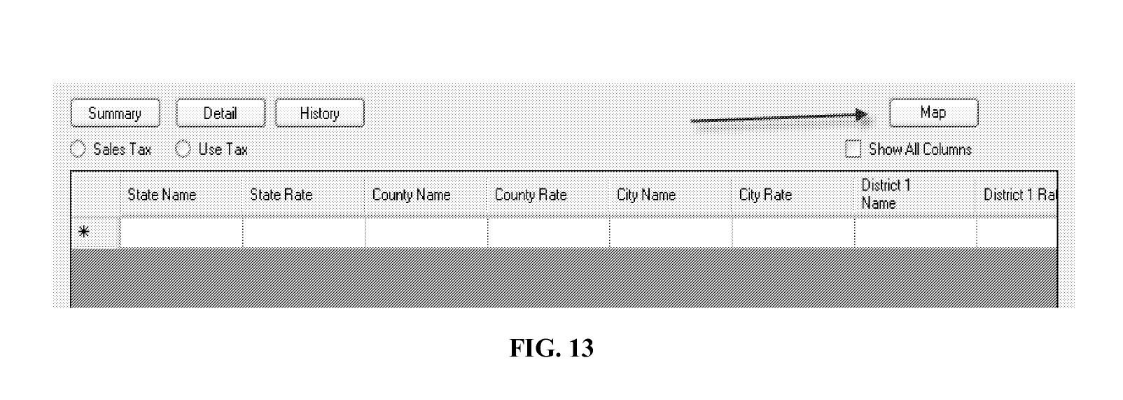

In one aspect, as illustrated in FIG. 13, a “Map” location option can become active when a Geocode is selected. If the agent (end-user device, client computer, . . . ) selects this option, the location screen is activated and the Geocode can persist over to the location screen. The location screen can also display potential locations for assignment based on the jurisdictions used in the search for the selected Geocode.

### Location Screen

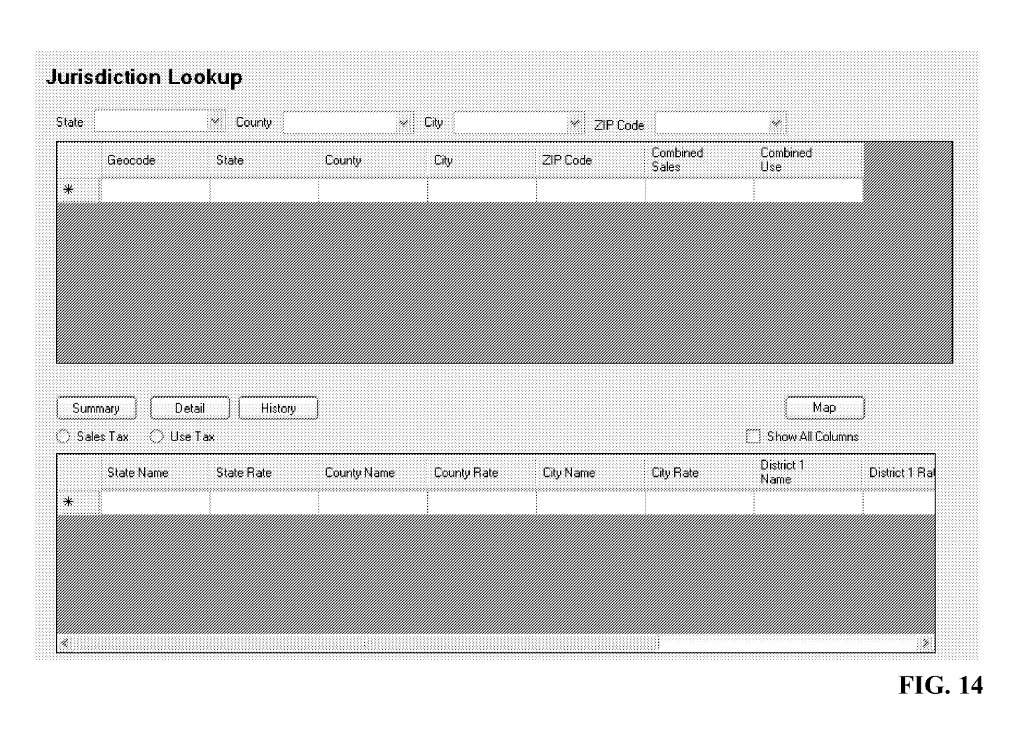

The GUI presented in FIG. 14 can permit the agents (end-user device, client computer, . . . ) to provide (e.g., input) their locations and associate them to a single Geocode. The agent (end-user device, client computer, . . . ) can have, desire, or benefit from, the ability to import their business locations and utilize the acquisition (e.g., lookup) functionality to assign a Geocode to these locations. The locations can have a physical address to enter. As an illustration, the fields for locations can include:
Location Name
Location Code
Parent Company
Street Address 1
Street Address 2
County
City
State
Country
Zip Code
Location Display

The locations, either manually entered or imported, can be displayed in a tree view that is easy for an agent (e.g., end-user device, client computer, . . . ) to navigate. As an example, FIG. 16 illustrates an example tree view comprising four levels, Super User, Parent Company, Company, and Locations. In one aspect, locations can have a child relationship to the Company. In another aspect, Companies can have a child relationship to the Parent Companies and Parent Companies can have a child relationship to the Super User (see, e.g., Update Super User Treeview below). All agent roles are more fully described in Section 6 below. In certain scenarios, if a location has no Geocode mapped to it, it can be displayed in the correct level in bold as to visually notify the agent (end-user device, client computer, . . . ) that the Location needs to be mapped. In certain implementations, a soft actuator (e.g., soft button), or toggle, can be available as more fully described in Section 6 herein. For instance, the toggle can be the first filter above the treeview in the screenshot below that filters on mapped, unmapped, or “all”.

### Location Options

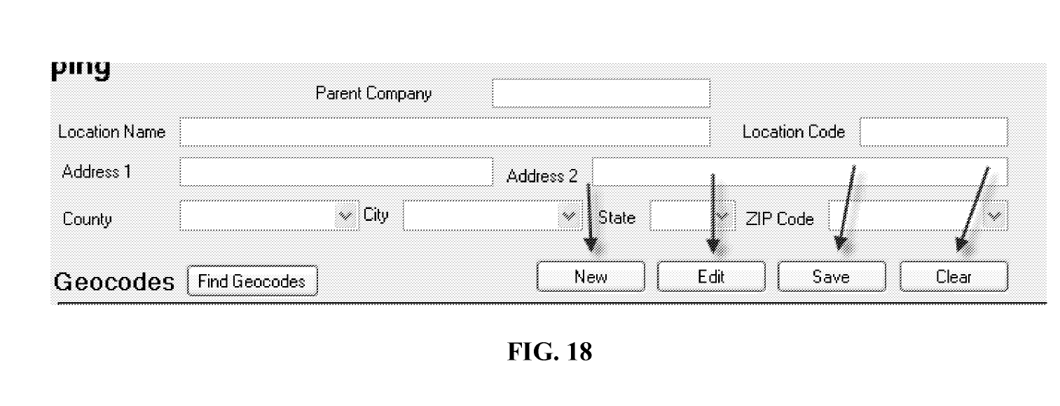

When a location is entered, the agent (end-user device, client computer, . . . ) can be able to assign a Geocode to that location. The data entered into the location record can be used to return all relevant Geocodes for the jurisdictions and ZIP code that was entered. This functionality is described herein. In one aspect, as illustrated in FIG. 18, options for the following functions can be available:
Create New Location
Edit existing locations
Save a Location
Clear the Location filter grid

In one aspect, the tax rates can be displayed in response to selecting the Geocode. The agent (end-user device, client computer, or the like) can then assign that selected Geocode to the location record and store the association.

### Administration Screen

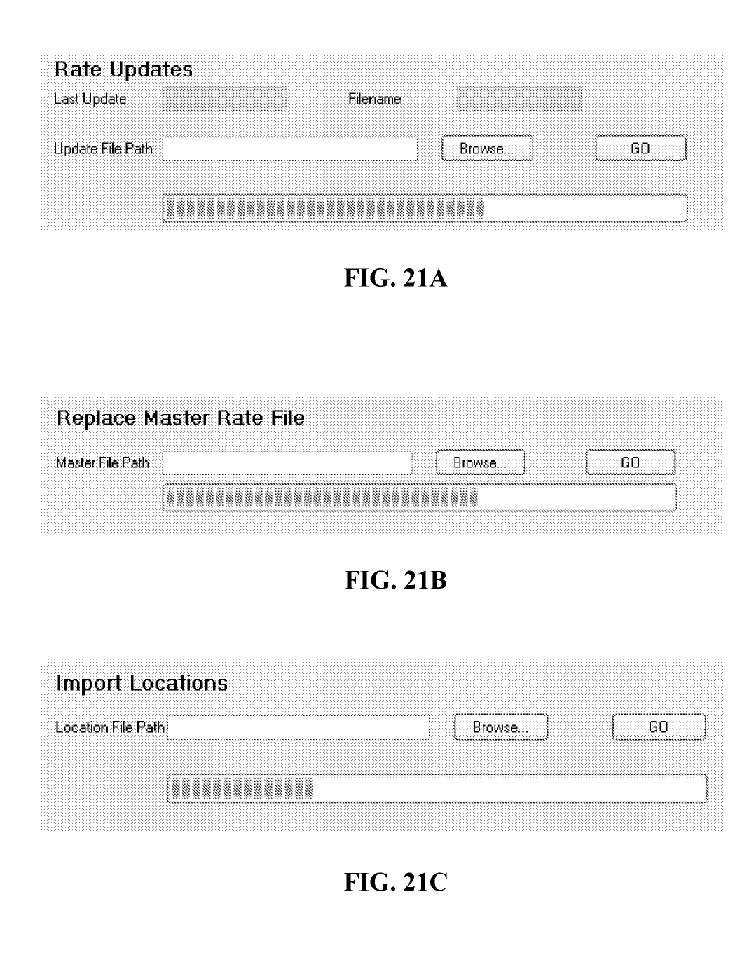

An administration (or “admin”) GUI can permit the agents (end-user devices, client computers, . . . ) to update their rates, import locations and produce a location rate change report. FIGS. 21A-21C illustrate various example admin GUIs.

### Updates

Updates to the rates can be sent out every month or in accordance with other predetermined periodicity or a specific schedule. The agent (end-user device, client computer, . . . ) can be allowed to select a file and process it to install any new rate changes in the data. There can be a rendering (e.g., a displayed screen) conveying the last date the file was updated. There can also be a browse feature that can permit the agent (end-user device, client computer, . . . ) to point to the update file. When the agent (end-user device, client computer, . . . ) clicks to update feature, a progress bar, or other indicia, can show the agent completion status.

### Import Locations

The agent (end-user device, client computer, or the like) can be permitted to import multiple locations from a file or other data container. As an example, the file can be in a comma-separated valued (csv) format, and can include a portion or all of the fields described herein. It can have a browses functionality so the agent (end-user device, client computer, . . . ) can point to the create file for import. As illustrated in FIG. 21C, after the agent activates the feature, a progress bar or other indicia (visual, aural, etc.) can be visible to notify the agent of completion status.

### Location Rate Change Report

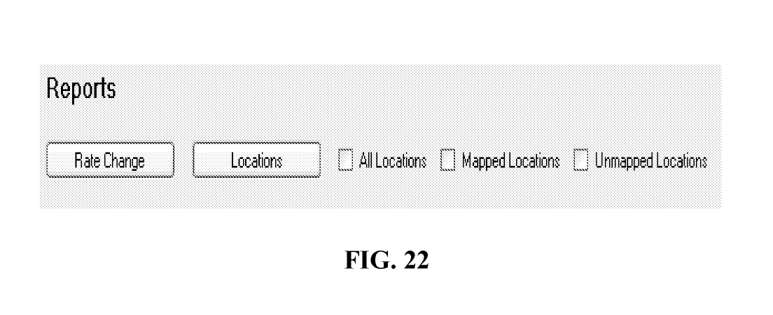

After an update is performed, a report can be generated that conveys any location where the assigned Geocode changed was updated in the process. FIG. 22 illustrates an example GUI that can permit triggering generation such report. In one aspect, the report can convey the location and the new tax rates assigned to it. In another aspect, the report can display on screen, or render in other media or devices, and be exportable to text, xls, csv or xml. There can also be a second report that shows all location information. The location report can include the ability for agents (end-user devices, client computers, . . . ) to choose which locations they want report on; Mapped, Unmapped or All locations. This report can be exportable in the same formats as the tax rate report.

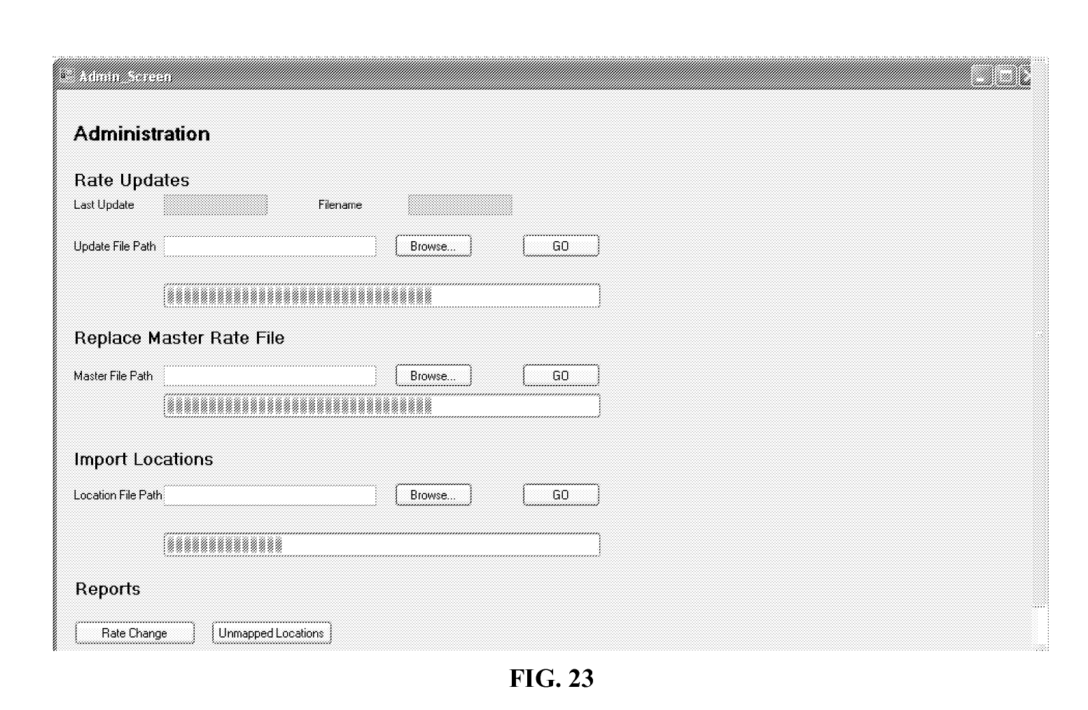

FIG. 23 illustrates an example administration GUI including interfaces for various of the foregoing administration functions.

### Multi-Tenancy

The concept of multi-tenancy includes the concept of a super user, along with the concepts of parent company, company, admin and user. Certain aspects of multi-tenancy are set forth below.

### Additional Exemplary Features

Storage of tax rates and historical data related thereto can be push the history into a separate table in order to realize performance improvements. In certain implementations, an effective date of a tax rate can be included in a table that is part of a database that comprises tax rates. In addition, at least one field can be added in the table to convey which one is the latest so that a query directed to the table can be faster to eliminate history records. In certain implementations, at least a portion of historical data related to tax rates can be moved to a specific table in the database. In one aspect, a SQL query can be updated to pull the relevant effective dates for the rates at all levels. Layouts in a GUI can display such data.

In addition, in certain embodiments, multi-tenancy levels as set forth below can include a requirement that historical data related to tax rates be tracked by company, as some companies, based on various factors, may desire not to apply updates.

### Company Structure

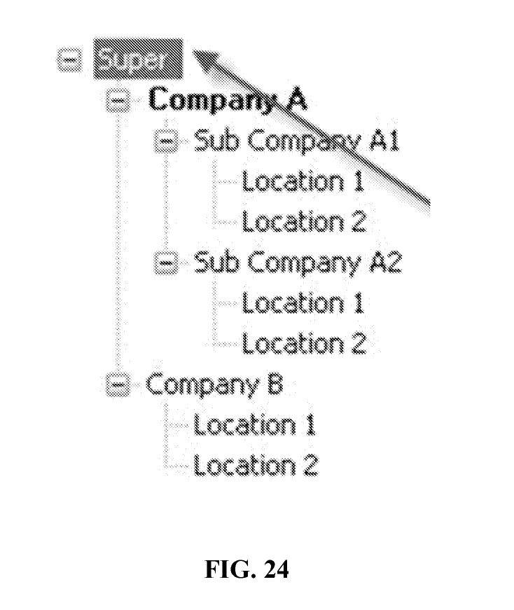

Company structure can comprise four levels. As an example, a tree view representative of the company structure is illustrated in FIG. 24.

### User Roles

In one aspect, three types of agent roles, or user roles, can be included in multi-tenancy: Super, Admin and User. The Super user can have control of the entire system and can perform any functions that the Admin and User can do—for any company. It is not limited to any specific company or location. It is assigned to the root company and all companies associated to it. In contrast, Admin users can be assigned to specific companies within the hierarchy. Admin users can have rights to all sub-locations of that company and the ability to update rates for that company, as well as perform any operation available to a standard user. A Standard user can be assigned to a specific company or companies. In certain scenarios, a Standard user may be configured so as to not update a tax rate file, while being configured to perform all the other functions including the import and mapping of locations as well as reporting and rate lookups. The buttons on the rate updates can be disabled for the standard user. The following is an example of the revised tree structure that shows a Super User sitting on top of a chain of parent companies that may have one or more child companies. Each company may have one or more child locations.

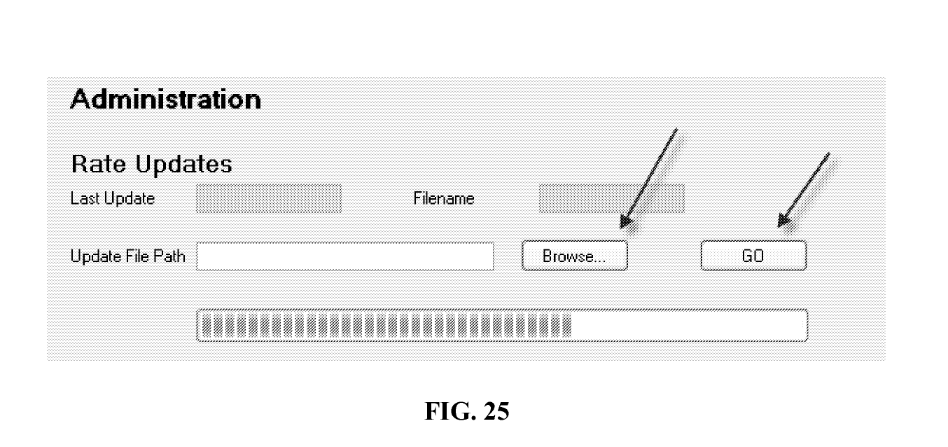

As illustrated in FIG. 25, the update of rates buttons can be active for certain users, such as an Admin user, and inactive for other users.

### Company Filters

There can be many locations associated with a company. This may complicate locating a single location in the tree view hierarchy. In one aspect, to mitigate or avoid any complications, a standard view can be created, wherein the standard view can be “filtered down” with five separate filters to return reduced result sets for the treeview. The default view can present all locations for all companies. It should be appreciated that such default has the potential to be large and unwieldy amount of data in the treeview. As filters are applied, the treeview can refresh with reduced datasets created through the filtering process.

Exemplary Filter 1: By company: The first filter can be “company” so that if a parent company has N children (with N a positive integer), a super user, admin, or standard user linked to more than one company can filter the results to the company that they need to work with. The filter can be configured through at least one selection option in the filter.

Exemplary Filter 2: Mapped and Unmapped Locations: There can be three states for this filter: all, mapped, unmapped. For example, “all” can cause to display all locations, mapped or unmapped, for the selected company or companies. In an implementation, unmapped items can be displayed in bold to distinguish them from mapped locations. As another example, “mapped” can cause to display only those locations that are mapped and so on.

Exemplary Filter 3: State selection. An agent (an end-user device, a client computer, . . . ) can utilize this selection to choose a State from a list of all the States that were associated with a company's locations. In certain embodiments, such selection can be a mandatory selection if a user wants to then filter on county and city (e.g., the fourth and fifth filters, respectively, as described below).

Exemplary Filter 4: County selection. After the State has been selected, any counties in that State that have been associated with locations can be populated when this filter is applied.

Exemplary Filter 5: City selection. After a State has been selected, any cities in that State that have been associated with locations can be populated when this filter is applied.

It should be appreciated that, in one or more embodiments, exemplary Filters 4 and 5 can be available (e.g., selectable) in response to selection of a State in the exemplary filter 3.

### Tax Rate Updates

The tax rate updates can be performed by a Super User or an Admin user. Such updates are applied in a logical numeric order in which can be rendered (e.g., displayed on a screen), unless the agent (e.g., end-user device, client computer, or the like) can elect to overwrite all data with a new import of the “master data”. Therefore, the update files can have a standard naming convention that permits tracking the sequence of incremental updates. In certain embodiments, agents can be prevented from applying incremental updates out of sequence. As an illustration, the file naming convention can be “UpdateNum_DateOfUpdate.csv” The label “UpdateNum” can be exploited to identify the incremental version to enforce the above rules that maintain the sequence.

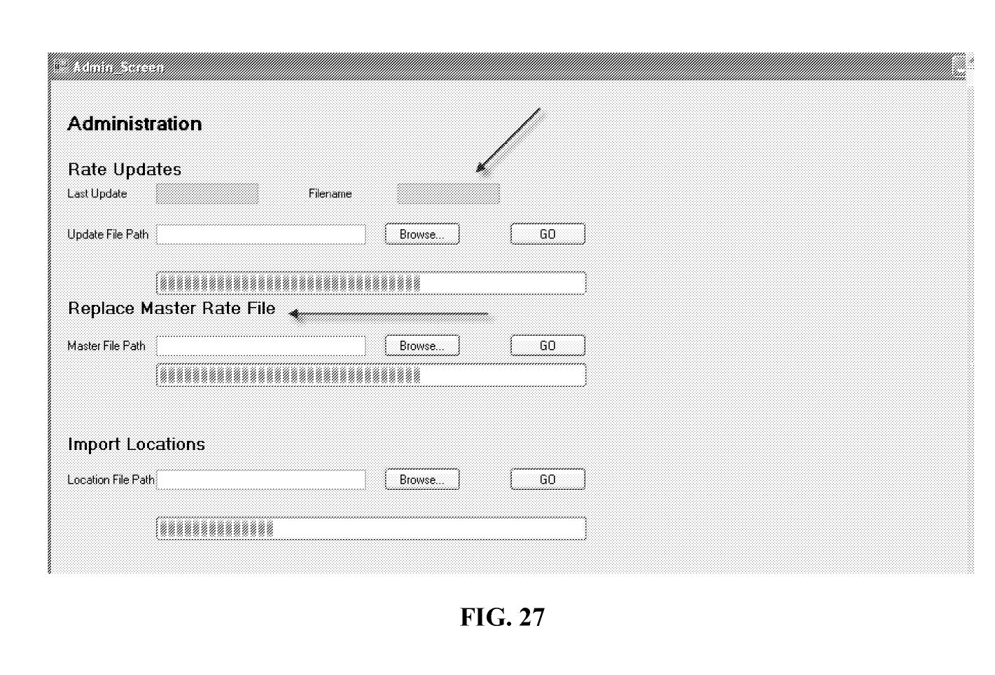

In certain embodiments, the filename of the last update supplied along with the date on which it was applied can be rendered (e.g., displayed on a device). This data can be leveraged to keep the rate history of update in the database—by company. A function to apply a master set of data, if the user chooses to do so, can be available. If this functionality is used, then a warning message can be conveyed (e.g., in a pop-up window in a display) to an agent utilizing the functionality. For example, the warning message may indicate “You are about to replace the Master Rate File, do you wish to continue?” There can be a Yes/No option buttons (e.g., soft buttons). If “Yes” is selected then continue the process. If “No” is selected then abort the process and return to the Admin screen. See, e.g., FIG. 27.

### Database Connections

In one aspect, since only Admin and Super users can update rate files and there is the ability for multi-tenancy, client specific data can be kept in separate databases of different schemas in the same database. The assigning of a database can occur, exclusively or non-exclusively, on a company level. All sub-companies and locations can utilize the rate data from this parent company.

### Import Specifications:

In certain embodiments, the following layout can be available for all location imports:

parentCo, locName, add1, add2, county, city, state, zip, locCode. In one aspect, “parentCo” can represent the name of the parent company and can default to the root company if there was only 1. In another aspect, “locCode” is the unique location code, if any, supplied with a location. In yet another aspect, of all these data elements, only “locName” and “parentCo”—the name of the actual location and the company to which it belongs—may be mandatory. In such scenario, in response to a match for a field not being indentified in response to importing one or more locations, the field could be mapped to a state, county, city, etc. As an example, the unmatched field can appear in the left hand tree view as “unmapped” by default upon import due to the lack of address information.

One or more embodiments, e.g., example system 100 or example system 200, can exploit a series of logic, referred to as “chopping” logic, to attempt matching or match information representative of a location to a data structure representative of such location, e.g., a geocode. In certain implementations, the chopping logic, also referred to as matching logic, can be executed (e.g., by the A&M server 110 or the A&M server 240) through a specific function call or other group of computer-executable instructions. The chopping logic permits to look for matches based on a hierarchically ordered alternative matching, such as the following hierarchy:
1. State+County+City+ZIP
2. State+City+ZIP
3. State+County+City
4. State+ZIP
5. State+City
6. ZIP

Accordingly, to generate a geocode, or match a location to a location data structure, the unit (e.g., the A&M server 110 or the A&M server 240) that performs the matching can such matching based on the foregoing hierarchically ordered matching. In one scenario, if a part of the information representative of the location is not spelled correctly, a system that executes the chopping logic, such as the A&M server 110 or the A&M server 240, may not find a match and can proceed to the next level in the hierarchy. In another scenario, the system can return the multiple records found in this hierarchy for the lookup. If no records are found after this logic it is fine to return “No Matching Records”. In yet another scenario, if the system is importing locations, the first single record match of the foregoing six exemplary combinations can be assigned to the location. If no single matches are found, the location can be characterized as unmapped.

### Bootstrapping

Embodiments of the subject disclosure can include an initial group of data sets related to tax rates and location information (e.g., geocodes or other data structure). Such initial data can be updated. For instance, an update can be incremental or a master data refresh can be implemented on a “go-forward” basis.

When compared with conventional technologies for tax rate acquisition, various advantages of the disclosure over such technologies emerge from the subject specification and annexed drawings. Examples of such advantages include the following: (1) Locations and hierarchical company structures can be retained (e.g., stored or persisted) in rate application. Availability of locations can permit tax rate tracking. Availability of companies and sub-companies can permit user roles by entity, e.g., User A can work on certain division that User B cannot have access to and vice versa. (2) Automatic resolution of addresses to tax jurisdictions. Native “chopping” logic on data acquisition in response to importing locations. Enhanced integration with geospatial engine. (3) Automatic assignment of tax rates to business locations. (4) Automatic updates of tax rates for the business locations. (5) Reports on tax rates changes by business locations. (6) Data mining utilized to quantify risk of jurisdictional assignment. (7) Data mining utilized to replay transactions and/or locations over time to permit audit defense and audit recovery.

While the systems, devices, apparatuses, protocols, processes, and methods have been described in connection with exemplary embodiments and specific illustrations, it is not intended that the scope be limited to the particular embodiments set forth, as the embodiments herein are intended in all respects to be illustrative rather than restrictive.

Unless otherwise expressly stated, it is in no way intended that any protocol, procedure, process, or method set forth herein be construed as requiring that its acts or steps be performed in a specific order. Accordingly, in the subject specification, where description of a process or method does not actually recite an order to be followed by its acts or steps or it is not otherwise specifically recited in the claims or descriptions of the subject disclosure that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

It will be apparent to those skilled in the art that various modifications and variations can be made in the subject disclosure without departing from the scope or spirit of the subject disclosure. Other embodiments of the subject disclosure will be apparent to those skilled in the art from consideration of the specification and practice of the subject disclosure as disclosed herein. It is intended that the specification and examples be considered as non-limiting illustrations only, with a true scope and spirit of the subject disclosure being indicated by the following claims.

What is claimed is:

1. A system, comprising:
a memory comprising computer-executable instructions and data; and
a processor functionally coupled to the memory and configured, by the computer-executable instructions,
to receive data representative of a location;
to associate the location to a data structure indicative of the location, the data structure residing in the memory and being mapped to a tax jurisdiction;
to access the tax jurisdiction associated with the data structure; and
to assign a tax rate to the location based on the tax jurisdiction.

2. The system of claim 1, wherein the data representative of the location is received from a mobile device.

3. The system of claim 1, wherein the processor is further configured to associate the location to the data structure based on hierarchically ordered matching.

4. The system of claim 1, wherein the processor is further configured by the computer-executable instructions to store the data representative of the location in the memory.

5. The system of claim 1, wherein to access the tax jurisdiction associated with the data structure, the processor is further configured to identify the tax jurisdiction.

6. The system of claim 1, wherein to access the tax jurisdiction associated with the data structure, the processor is further configured to receive the tax jurisdiction.

7. A method, comprising:
receiving, by a computer, data representative of a location;
associating, by the computer, the location to a data structure indicative of the location, the data structure being mapped to a tax jurisdiction;
accessing, by the computer, the tax jurisdiction associated with the data structure; and
assigning a tax rate to the location based on the tax jurisdiction.

8. The method of claim 7, wherein the receiving step comprises receiving the data from a mobile device.

9. The method of claim 7, further comprising conveying, by the computer, information comprising data indicative of the tax rate.

10. The method of claim 9, further comprising conveying, by the computer, information related to the tax jurisdiction.

11. The method of claim 7, wherein the associating step comprises matching the location to the data structure according to a hierarchically ordered matching.

12. The method of claim 7, wherein the accessing step comprises identifying the tax jurisdiction.

13. The method of claim 7, wherein to accessing step comprises receiving the tax jurisdiction.

14. A computer-readable non-transitory medium, comprising:
a first group of computer-executable instructions that, in response to execution, cause a processor to receive data representative of a location;
a second group of computer-executable instructions that, in response to execution, cause the processor to associate the location to a data structure indicative of the location, the data structure being mapped to a tax jurisdiction;
a third group of computer-executable instructions that, in response to execution, cause the processor to identify the tax jurisdiction associated with the data structure; and
a fourth group of computer-executable instructions that, in response to execution, cause the processor to assign a tax rate to the location based on the tax jurisdiction.

15. The computer-readable non-transitory medium of claim 14, wherein the data representative of the location is received from a mobile device.

16. The computer-readable non-transitory medium of claim 14, further comprising a fifth group of computer-executable instructions that, in response to execution, cause the processor to retain the data representative of the location in the memory.

17. A mobile device, comprising:
a memory comprising computer-executable instructions and data; and
a processor functionally coupled to the memory and configured, by the computer-executable instructions, to:
transmit data representative of a location to a location-based tax rate acquisition engine; and
receive, from the location-based tax rate acquisition engine, a tax rate associated to a tax jurisdiction related to the location in response to the transmission of the data.

18. The mobile device of claim 17, wherein the processor is further configured, by the computer-executable instructions, to receive information related to the tax rate.

19. The mobile device of claim 17, wherein the processor is further configured, by the computer-executable instructions, to receive information related to the tax jurisdiction.
